(19) United States
(12) Patent Application Publication
(10) Pub. No.: US 2026/0238425 A1
(43) Pub. Date: Aug. 13, 2026

(54) DYNAMICALLY TRIGGERED EARLY SRS FOR EARLY PRECODING

(71) Applicant: QUALCOMM Incorporated, San Diego, CA (US)

(72) Inventors: Yan ZHOU, San Diego, CA (US); In-Soo KIM, San Diego, CA (US); Tao LUO, San Diego, CA (US); Le LIU, San Jose, CA (US); Mahmoud TAHERZADEH BOROUJENI, San Diego, CA (US); Yi HUANG, San Diego, CA (US); Kianoush HOSSEINI, San Diego, CA (US)

(21) Appl. No.: 19/232,678

(22) Filed: Jun. 9, 2025

Related U.S. Application Data
(60) Provisional application No. 63/758,237, filed on Feb. 13, 2025.

(51) Int. Cl. H04L 5/00; H04W 74/0833

(52) U.S. Cl. CPC H04L 5/0048; H04W 74/0833

(57) ABSTRACT

Methods, systems, and devices for wireless communications are described. A user equipment (UE) may provide an indication of the supported sounding reference signal (SRS) transmission capability of the UE to a network entity for early SRS transmission (e.g., SRS transmission after initiation of a random access channel (RACH) procedure with the network entity and prior to reception of the registration accept message from the network entity that corresponds to the RACH procedure). The UE may transmit early SRSs in accordance with an SRS configuration based on the indication of the SRS transmission capability. The network entity may use the SRSs to perform channel estimation and select parameters (such as precoders) for downlink and/or uplink communications with the UE. Indication of an SRS capability for early SRS transmission accordingly may reduce the time to establish data communication between a UE and a network entity.

### CROSS REFERENCE

The present Application for Patent claims the benefit of U.S. Provisional Patent Application No. 63/758,237 by Zhou et al., entitled “DYNAMICALLY TRIGGERED EARLY SRS FOR EARLY PRECODING,” filed Feb. 13, 2025, assigned to the assignee hereof, and expressly incorporated by reference herein.

### FIELD OF TECHNOLOGY

The following relates to wireless communications, including early sounding reference signal (SRS) capability signaling. In some aspects, the early SRS capability signaling is dynamically triggered. In some aspects, the early SRS capability signaling allows for early precoding.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a message to a network entity, where the message or transmission of the message is indicative of a sounding reference signal (SRS) capability supported by the UE, where the SRS capability is associated with early SRS transmission, where the early SRS transmission is after initiation by the UE of a random access channel (RACH) procedure with the network entity and prior to reception by the UE of a corresponding registration acceptance message from the network entity associated with the RACH procedure and transmitting a set of SRSs in accordance with a SRS configuration that is based on the SRS capability.

A UE for wireless communications is described. The UE may include one or more memories storing processor executable code, and one or more processors coupled with the one or more memories. The one or more processors may individually or collectively be operable to execute the code to cause the UE to transmit a message to a network entity, where the message or transmission of the message is indicative of a SRS capability supported by the UE, where the SRS capability is associated with early SRS transmission, where the early SRS transmission is after initiation by the UE of a RACH procedure with the network entity and prior to reception by the UE of a corresponding registration acceptance message from the network entity associated with the RACH procedure and transmit a set of SRSs in accordance with a SRS configuration that is based on the SRS capability.

Another UE for wireless communications is described. The UE may include means for transmitting a message to a network entity, where the message or transmission of the message is indicative of a SRS capability supported by the UE, where the SRS capability is associated with early SRS transmission, where the early SRS transmission is after initiation by the UE of a RACH procedure with the network entity and prior to reception by the UE of a corresponding registration acceptance message from the network entity associated with the RACH procedure and means for transmitting a set of SRSs in accordance with a SRS configuration that is based on the SRS capability.

A non-transitory computer-readable medium storing code for wireless communications is described. The code may include instructions executable by one or more processors to transmit a message to a network entity, where the message or transmission of the message is indicative of a SRS capability supported by the UE, where the SRS capability is associated with early SRS transmission, where the early SRS transmission is after initiation by the UE of a RACH procedure with the network entity and prior to reception by the UE of a corresponding registration acceptance message from the network entity associated with the RACH procedure and transmit a set of SRSs in accordance with a SRS configuration that is based on the SRS capability.

In some examples of the method, UEs, and non-transitory computer-readable medium described herein, the message may be an initial message of the RACH procedure and the message includes an indication of the SRS capability.

In some examples of the method, UEs, and non-transitory computer-readable medium described herein, the indication in the initial message indicates the SRS capability from a set of multiple candidate SRS capabilities based on a RACH occasion via which the initial message may be transmitted or a transmission parameter of the initial message and the set of multiple candidate SRS capabilities may be mapped to different RACH occasion or different transmission parameters.

Some examples of the method, UEs, and non-transitory computer-readable medium described herein may further include operations, features, means, or instructions for receiving, from the network entity and based on the initial message, a second message of the RACH procedure that triggers the set of SRSs and indicates the SRS configuration for the set of SRSs.

Some examples of the method, UEs, and non-transitory computer-readable medium described herein may further include operations, features, means, or instructions for receiving, from the network entity, system information (SI) that indicates a set of multiple indices associated with respective SRS configurations and receiving, from the network entity and based on the initial message, a second message of the RACH procedure that triggers the set of SRSs and indicates an index from the set of multiple indices, where the index indicates selection of the SRS configuration.

Some examples of the method, UEs, and non-transitory computer-readable medium described herein may further include operations, features, means, or instructions for receiving, from the network entity, SI that indicates a set of multiple SRS capabilities, where the set of multiple SRS capabilities includes the SRS capability.

In some examples of the method, UEs, and non-transitory computer-readable medium described herein, the message may be a random access message of the RACH procedure, the message includes an indication of the SRS capability, and the message indicates one or more SRS transmission parameters in addition to the SRS capability.

In some examples of the method, UEs, and non-transitory computer-readable medium described herein, transmitting the message may include operations, features, means, or instructions for transmitting the set of SRSs in accordance with the SRS capability.

Some examples of the method, UEs, and non-transitory computer-readable medium described herein may further include operations, features, means, or instructions for receiving, from the network entity, a request for SRS capability information from the UE, where transmission of the message may be based on the request.

In some examples of the method, UEs, and non-transitory computer-readable medium described herein, receiving the request may include operations, features, means, or instructions for receiving the request via SI.

Some examples of the method, UEs, and non-transitory computer-readable medium described herein may further include operations, features, means, or instructions for transmitting an initial message of the RACH procedure, receiving, from the network entity, a second message of the RACH procedure based on the initial message, where the second message includes the request, and transmitting, to the network entity and based on the request, a third message of the RACH procedure, where the third message may be the message.

In some examples of the method, UEs, and non-transitory computer-readable medium described herein, transmitting the message may include operations, features, means, or instructions for transmitting a first initial access message of the RACH procedure via a first RACH occasion and in accordance with a first set of transmission parameters and transmitting a second initial access message of the RACH procedure via a second RACH occasion and in accordance with a second set of transmission parameters, where the message may be indicative of the SRS capability at least in part on an offset between the first RACH occasion and the second RACH occasion, the first set of transmission parameters, the second set of transmission parameters, or any combination thereof.

In some examples of the method, UEs, and non-transitory computer-readable medium described herein, message may be indicative of the SRS capability based on satisfaction of a triggering condition associated with the SRS capability.

Some examples of the method, UEs, and non-transitory computer-readable medium described herein may further include operations, features, means, or instructions for transmitting, prior to the reception by the UE of the corresponding registration acceptance message from the network entity, an indication of one or more additional operating parameters of the UE.

In some examples of the method, UEs, and non-transitory computer-readable medium described herein, randomly selecting a root sequence index, a cyclic shift, a comb offset, or a combination thereof to apply to transmission of the set of SRSs.

Some examples of the method, UEs, and non-transitory computer-readable medium described herein may further include operations, features, means, or instructions for transmitting a second message to the network entity that indicates the root sequence index, the cyclic shift, the comb offset, or the combination thereof.

In some examples of the method, UEs, and non-transitory computer-readable medium described herein, and the method, apparatuses, and non-transitory computer-readable medium may include further operations, features, means, or instructions for SRS scheduling type capability information, SRS type capability information, antenna port information; SRS antenna switching capability information, aperiodic SRS offset capability information, physical uplink shared channel capability information, or SRS triggering capability information.

Some examples of the method, UEs, and non-transitory computer-readable medium described herein may further include operations, features, means, or instructions for receiving, from the network entity and based on the message, a second message that indicates the SRS configuration, where the SRS configuration includes: a scheduling type of the set of SRSs, a quantity of resource sets associated with the set of SRSs, a quantity of resources per resource set of the quantity of resource sets, antenna port information, comb offset information, a root sequence, a cyclic shift, frequency hopping information, repetition information, spatial filter information, time offset information, transmission power control information, or codebook type information.

A method for wireless communications by a network entity is described. The method may include receiving a message from a UE, where the message or reception of the message is indicative of a SRS capability supported by the UE, where the SRS capability is associated with early SRS transmission, where the early SRS transmission is after initiation by the UE of a RACH procedure with the network entity and prior to transmission by the network entity of a corresponding registration acceptance message to the UE associated with the RACH procedure and receiving, from the UE, a set of SRSs in accordance with a SRS configuration that is based on the SRS capability.

A network entity for wireless communications is described. The network entity may include one or more memories storing processor executable code, and one or more processors coupled with the one or more memories. The one or more processors may individually or collectively be operable to execute the code to cause the network entity to receive a message from a UE, where the message or reception of the message is indicative of a SRS capability supported by the UE, where the SRS capability is associated with early SRS transmission, where the early SRS transmission is after initiation by the UE of a RACH procedure with the network entity and prior to transmission by the network entity of a corresponding registration acceptance message to the UE associated with the RACH procedure and receive, from the UE, a set of SRSs in accordance with a SRS configuration that is based on the SRS capability.

Another network entity for wireless communications is described. The network entity may include means for receiving a message from a UE, where the message or reception of the message is indicative of a SRS capability supported by the UE, where the SRS capability is associated with early SRS transmission, where the early SRS transmission is after initiation by the UE of a RACH procedure with the network entity and prior to transmission by the network entity of a corresponding registration acceptance message to the UE associated with the RACH procedure and means for receiving, from the UE, a set of SRSs in accordance with a SRS configuration that is based on the SRS capability.

A non-transitory computer-readable medium storing code for wireless communications is described. The code may include instructions executable by one or more processors to receive a message from a UE, where the message or reception of the message is indicative of a SRS capability supported by the UE, where the SRS capability is associated with early SRS transmission, where the early SRS transmission is after initiation by the UE of a RACH procedure with the network entity and prior to transmission by the network entity of a corresponding registration acceptance message to the UE associated with the RACH procedure and receive, from the UE, a set of SRSs in accordance with a SRS configuration that is based on the SRS capability.

In some examples of the method, network entities, and non-transitory computer-readable medium described herein, the message may be an initial message of the RACH procedure and the message includes an indication of the SRS capability.

In some examples of the method, network entities, and non-transitory computer-readable medium described herein, the indication in the initial message indicates the SRS capability from a set of multiple candidate SRS capabilities based on a RACH occasion via which the initial message may be transmitted or a transmission parameter of the initial message and the set of multiple candidate SRS capabilities may be mapped to different RACH occasion or different transmission parameters.

Some examples of the method, network entities, and non-transitory computer-readable medium described herein may further include operations, features, means, or instructions for transmitting, to the UE and based on the initial message, a second message of the RACH procedure that triggers the set of SRSs and indicates the SRS configuration for the set of SRSs.

Some examples of the method, network entities, and non-transitory computer-readable medium described herein may further include operations, features, means, or instructions for transmitting SI that indicates a set of multiple indices associated with respective SRS configurations and transmitting, to the UE and based on the initial message, a second message of the RACH procedure that triggers the set of SRSs and indicates an index from the set of multiple indices, where the index indicates selection of the SRS configuration.

Some examples of the method, network entities, and non-transitory computer-readable medium described herein may further include operations, features, means, or instructions for transmitting SI that indicates a set of multiple SRS capabilities, where the set of multiple SRS capabilities includes the SRS capability.

In some examples of the method, network entities, and non-transitory computer-readable medium described herein, the message may be a random access message of the RACH procedure, the message includes an indication of the SRS capability, and the message indicates one or more SRS transmission parameters in addition to the SRS capability.

In some examples of the method, network entities, and non-transitory computer-readable medium described herein, receiving the message may include operations, features, means, or instructions for receiving the set of SRSs in accordance with the SRS capability.

Some examples of the method, network entities, and non-transitory computer-readable medium described herein may further include operations, features, means, or instructions for transmitting, to the UE, a request for SRS capability information from the UE, where transmission of the message may be based on the request.

In some examples of the method, network entities, and non-transitory computer-readable medium described herein, transmitting the request may include operations, features, means, or instructions for transmitting the request via SI.

Some examples of the method, network entities, and non-transitory computer-readable medium described herein may further include operations, features, means, or instructions for receiving, from the UE, an initial message of the RACH procedure, transmitting, to the UE, a second message of the RACH procedure based on the initial message, where the second message includes the request, and receiving, from the UE and based on the request, a third message of the RACH procedure, where the third message may be the message.

In some examples of the method, network entities, and non-transitory computer-readable medium described herein, receiving the message may include operations, features, means, or instructions for receiving, from the UE, a first initial access message of the RACH procedure via a first RACH occasion and in accordance with a first set of transmission parameters and receiving, from the UE, a second initial access message of the RACH procedure via a second RACH occasion and in accordance with a second set of transmission parameters, where the message may be indicative of the SRS capability at least in part on an offset between the first RACH occasion and the second RACH occasion, the first set of transmission parameters, the second set of transmission parameters, or any combination thereof.

In some examples of the method, network entities, and non-transitory computer-readable medium described herein, message may be indicative of the SRS capability based on satisfaction of a triggering condition associated with the SRS capability.

Some examples of the method, network entities, and non-transitory computer-readable medium described herein may further include operations, features, means, or instructions for receiving, from the UE and prior to the transmission of the corresponding registration acceptance message from the network entity, an indication of one or more additional operating parameters of the UE.

Some examples of the method, network entities, and non-transitory computer-readable medium described herein may further include operations, features, means, or instructions for receiving, from the UE, a second message that indicates a root sequence index, a cyclic shift, a comb offset, or a combination thereof that may be applied to the set of SRSs.

In some examples of the method, network entities, and non-transitory computer-readable medium described herein, and the method, apparatuses, and non-transitory computer-readable medium may include further operations, features, means, or instructions for SRS scheduling type capability information, SRS type capability information, antenna port information; SRS antenna switching capability information, aperiodic SRS offset capability information, physical uplink shared channel capability information, or SRS triggering capability information.

Some examples of the method, network entities, and non-transitory computer-readable medium described herein may further include operations, features, means, or instructions for transmitting, to the UE and based on the message, a second message that indicates the SRS configuration, where the SRS configuration includes: a scheduling type of the set of SRSs, a quantity of resource sets associated with the set of SRSs, a quantity of resources per resource set of the quantity of resource sets, antenna port information, comb offset information, a root sequence, a cyclic shift, frequency hopping information, repetition information, spatial filter information, time offset information, transmission power control information, or codebook type information.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports early sounding reference signal (SRS) capability signaling in accordance with one or more aspects of the present disclosure.

FIG. 2 shows an example of a process flow that supports early SRS capability signaling in accordance with one or more aspects of the present disclosure.

FIG. 3 shows an example of a signaling diagram that supports early SRS capability signaling in accordance with one or more aspects of the present disclosure.

FIG. 4 shows an example of a signaling diagram that supports early SRS capability signaling in accordance with one or more aspects of the present disclosure.

FIG. 5 shows an example of a signaling diagram that supports early SRS capability signaling in accordance with one or more aspects of the present disclosure.

FIG. 6 shows an example of a signaling diagram that supports early SRS capability signaling in accordance with one or more aspects of the present disclosure.

FIG. 7 shows an example of a timing diagram that supports early SRS capability signaling in accordance with one or more aspects of the present disclosure.

FIG. 8 shows an example of a process flow that supports early SRS capability signaling in accordance with one or more aspects of the present disclosure.

FIGS. 9 and 10 show block diagrams of devices that support early SRS capability signaling in accordance with one or more aspects of the present disclosure.

FIG. 11 shows a block diagram of a communications manager that supports early SRS capability signaling in accordance with one or more aspects of the present disclosure.

FIG. 12 shows a diagram of a system including a device that supports early SRS capability signaling in accordance with one or more aspects of the present disclosure.

FIGS. 13 and 14 show block diagrams of devices that support early SRS capability signaling in accordance with one or more aspects of the present disclosure.

FIG. 15 shows a block diagram of a communications manager that supports early SRS capability signaling in accordance with one or more aspects of the present disclosure.

FIG. 16 shows a diagram of a system including a device that supports early SRS capability signaling in accordance with one or more aspects of the present disclosure.

FIGS. 17 and 18 show flowcharts illustrating methods that support early SRS capability signaling in accordance with one or more aspects of the present disclosure.

### DETAILED DESCRIPTION

In wireless communications systems, a user equipment (UE) may transmit sounding reference signals (SRSs) to enable the network entity to estimate the channel between the UE and the network entity and select parameters for communication between the UE and the network entity. For example, the network entity may select an uplink precoder and/or a downlink precoder based on measurements of SRSs received from a UE. A UE may perform a random access channel (RACH) procedure to access the network. To initiate the RACH procedure, the UE may transmit a random access preamble via an initial RACH message to the network entity in a RACH occasion (RO). For example, the initial RACH message may be a msg1 in a 4-step RACH procedure or a msgA in a 2-step RACH procedure. ROs may be indicated and/or mapped to synchronization signal blocks (SSBs) transmitted by (e.g., broadcast by) the network entity. An SSB may include synchronization signals and a master information block (MIB) that includes system information (SI) for the network entity. The network entity may also provide other SI via broadcast SI blocks (SIBs) such as SIB1 and other SIBs.

After a successful RACH procedure, the network entity and the UE may exchange capability information, such as supported SRS transmission capabilities of the UE. For example, the UE may transmit such capability information in a registration request message, and the network entity may transmit a registration accept message and may subsequently trigger SRS transmission by the UE in accordance with the indicated UE capability information. To speed up channel estimation at the network entity, and thus enable quicker establishment of data communications between the UE and the network entity, the network entity may trigger SRS transmission by the UE before the registration accept message that corresponds to a RACH procedure, which may be referred to as early SRS transmission. The network entity, however, may not be able to trigger SRS transmission for a UE without information associated with the supported SRS transmission capabilities of the UE.

The UE may provide an indication of the supported SRS transmission capability of the UE to a network entity after initiation of a RACH procedure with the network entity and prior to reception of the registration accept message from the network entity that corresponds to the RACH procedure. The UE may transmit early SRSs in accordance with an SRS configuration based on the indication of the SRS transmission capability. In some examples, the indication of the SRS capability may be based on a mapped RO or RACH parameter used to transmit an initial RACH message (e.g., a msg1/msgA). In some examples, the network entity may indicate (e.g., in SI), candidate SRS capabilities, and the UE may indicate a selected SRS capability of the candidate SRS capabilities (e.g., based on an index). In some examples, the UE may implicitly indicate the SRS capability of the UE based on transmission of the SRSs using an SRS capability of the candidate SRS capabilities. In some examples, the network entity may transmit (e.g., via a subsequent RACH message such as msg2 or msg3), an indication of an SRS configuration to apply to the SRS based on the indicated SRS capability. In some examples, the network entity may request an indication of the supported SRS transmission capability of the UE (e.g., via SI or a RACH message such as msg2), and the UE may indicate the SRS capability configuration based on the request.

Aspects of the disclosure are initially described in the context of wireless communications systems. Aspects of the disclosure are further illustrated by and described with reference to process flows, signaling diagrams, timing diagrams, apparatus diagrams, system diagrams, and flowcharts that relate to early SRS capability signaling. In some aspects, the early SRS capability signaling is dynamically triggered. In some aspects, the early SRS capability signaling allows for early precoding.

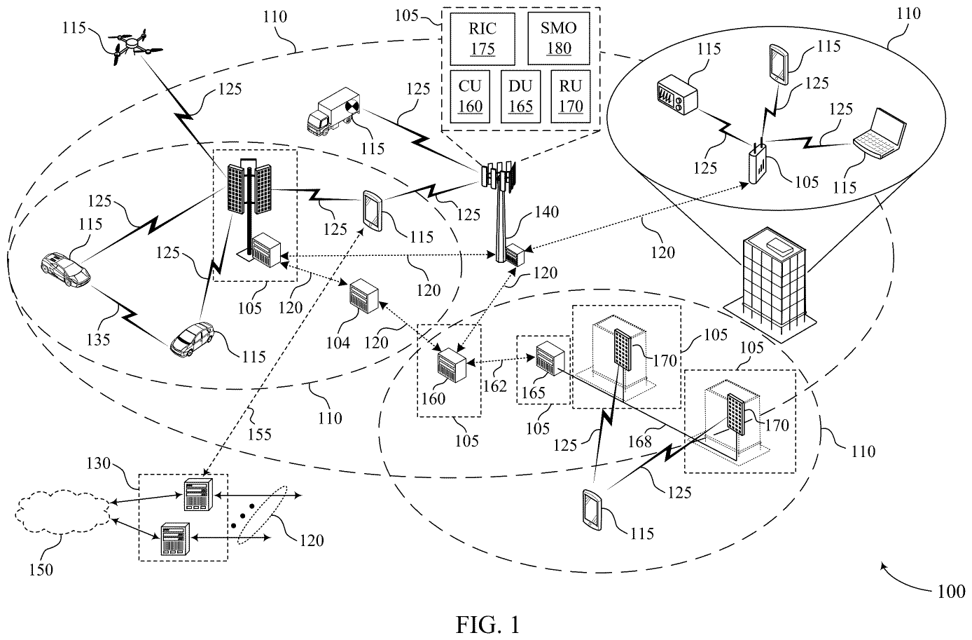

FIG. 1 shows an example of a wireless communications system 100 that supports early SRS capability signaling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support early SRS capability signaling as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, SI), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

As described herein, a UE 115 may transmit SRSs to enable the network entity 105 to estimate the channel between the UE 115 and the network entity 105 and select parameters (such as an uplink precoder and/or a downlink precoder) for communication between the UE 115 and the network entity 105. The network entity 105 may trigger the UE 115 to perform SRS transmission in accordance with an SRS configuration, which may indicate parameters for the UE 115 to apply to the transmission of the SRSs. Support of a given SRS configuration may be based on the UE capability to transmit SRSs. For example, in order to trigger the UE 115 to perform SRS transmission in accordance with a given SRS configuration, the network entity 105 may first receive capability information from the UE 115 that indicates the UE 115 supports the parameters associated with the given SRS configuration. For example, SRS parameters that may be reported as an SRS capability of the UE 115 may include antenna switching (including xTyR combinations, where xT indicates a quantity x of transmission antennas and yR indicates a quantity y of receive antennas), SRS for codebook (CB), SRS for non-CB (NCB), and SRS for beam management (BM). In some examples, support of a single resource with single port SRS for CB physical uplink shared channel (PUSCH) may be a mandatory feature. UE capabilities for SRS configurations may be indicated in feature groups (FGs), such as in FG 2-52, FG 2-53, and FG 23-8 of the Third Generation Partnership Project (3GPP) TS 38.822. Support of type-1 channel state information (CSI) feedback may be a mandatory UE feature for two, four, and eight transmit antenna codebooks with periodic and/or aperiodic CSI reports, as in FG 2-32 and/or FG2-55 of 3GPP TS 38.822v 16.0.0.

A UE 115 may perform a RACH procedure to access the network. To initiate the random access procedure, the UE 115 may transmit a random access preamble via an initial RACH message to the network entity 105 in an RO. For example, the initial RACH message may be a msg1 in a 4-step RACH procedure or a msgA in a 2-step RACH procedure. ROs may be indicated and/or mapped to synchronization signal blocks (SSBs) transmitted by (e.g., broadcast by) the network entity 105.

To speed up channel estimation at the network entity 105, and thus enable quicker establishment of data communications between the UE 115 and the network entity 105, the network entity 105 may trigger SRS transmission by the UE 115 before the registration accept message that corresponds to a RACH procedure. Accordingly, the UE 115 may provide an indication of the supported SRS transmission capability of the UE 115 to a network entity 105 after initiation of a RACH procedure with the network entity 105 and prior to reception of the registration accept message from the network entity 105 that corresponds to the RACH procedure. The UE 115 may transmit early SRSs in accordance with an SRS configuration based on the indication of the SRS transmission capability.

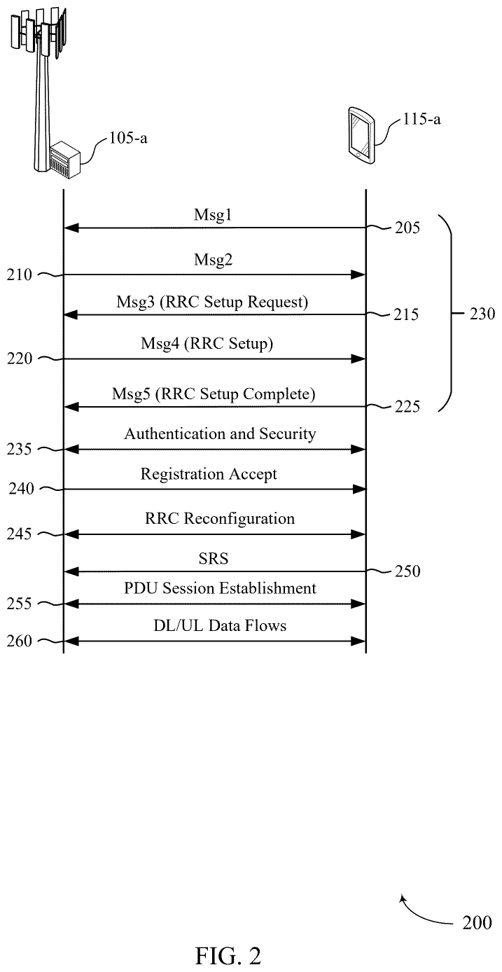

FIG. 2 shows an example of a process flow 200 that supports early SRS capability signaling in accordance with one or more aspects of the present disclosure. The process flow 200 may implement or may be implemented by aspects of the wireless communications system 100. For example, the process flow 200 may include a UE 115-a, which may be an example of a UE 115 as described herein. The process flow 200 may also include a network entity 105-a, which may be an example of a network entity 105 as described herein. In the following description of the process flow 200, the communications between the network entity 105-a and the UE 115-a may be transmitted in a different order than the example order shown, or the operations performed by the network entity 105-a and the UE 115-a may be performed in different orders or at different times. Some operations may also be omitted from the process flow 200, and other operations may be added to the process flow 200.

The process flow 200 may illustrate an example RACH procedure 230 between the UE 115-a and the network entity 105-a and subsequent signaling to establish data communication between the UE 115-a and the network entity 105-a at 260.

For example, to initiate the RACH procedure 230, at 205 the UE 115-a may transmit a msg1 to the network entity 105-a, which may include a random access preamble (such as a Zadoff-Chu sequence). In response to the msg1 at 205, at 210, the network entity 105-a may transmit a msg2 to the UE 115-a. The msg2 at 210 may indicate a resource (e.g., a time-frequency resource) for the UE 115-a to transmit an msg3. At 215, the UE 115-a may transmit a msg3 to the network entity 105-a using the resource indicated by the msg2. The msg3 may include an RRC setup request. In response to the msg3, at 220, the network entity 105-a may transmit a msg4 to the UE 115-a. The msg4 may include a contention resolution (for contention based random access (CBRA)) which may include the UE identity. The msg4 may indicate a cell radio network temporary identifier (C-RNTI) for the UE 115-a. The msg4 may include an RRC setup message in response to the RRC setup request in the msg3. At 225, The UE 115-a may respond to the RRC setup message in the msg4 via transmission of a msg5 to the network entity 105-a that may include an RRC setup complete message. The msg5 may acknowledge reception of the msg4. In some examples, the msg5 at 225 may indicate a UE SRS capability.

At 235, the UE 115-a and the network entity 105-a may exchange authentication and security information. At 240, the network entity 105-a may transmit a registration accept message corresponding to the RACH procedure 230, and the UE 115-a may be registered with the network entity 105-a.

In some examples, at 245, the network entity 105-a and the UE 115-a may perform RRC reconfiguration (e.g., to configure one or more parameters for communication between the UE 115-a and the network entity 105-a). In some examples, at 250, the UE 115-a may transmit one or more SRSs to the network entity 105-a in accordance with the UE SRS capability. At 255, the network entity 105-a and the UE 115-a may establish a packet data unit (PDU) session. At 260, based on the SRSs and the establishment of the PDU session, the network entity 105-a and the UE 115-a may communicate data.

In some examples, absent a UE capability of early SRS transmission, for a UE in an RRC idle mode, the soonest the UE 115-a may transmit SRS may be after RRC reconfiguration at 245 (e.g., the UE 115-a may transmit the SRSs at 250 after RRC reconfiguration at 245 as shown in the process flow 200). Waiting until after RRC configuration to transmit SRSs may involve lengthy authentication and security processes (e.g., at 235 and at 245).

For a UE in an RRC inactive mode prior to the RACH procedure 230, the msg5 may include an RRC resume message, which may restore a previous RRC reconfiguration. Accordingly, for a UE in the RRC inactive mode, msg4 at 220 may indicate updated RRC parameters based on the network-stored UE capability, and accordingly the UE may transmit SRSs after msg5 at 225 if the UE was in the RRC inactive mode prior to the RACH procedure 230. Accordingly, if the UE 115-a is in the RRC inactive mode prior to the RACH procedure 230, the UE 115-a and the network entity 105-a may resume downlink and uplink data flow at 260 after the RRC resume is completed at the msg5 stage at 225 (e.g., without performing 235-245).

In some examples, the SRS transmission and CSI reporting may not be triggered during an inactive UE small data transmission (SDT), which may support only fallback downlink control information (DCI). In inactive UE SDT, the downlink response for the RRC resume request may not contain any RRC message to update RRC parameters for SRS or channel state feedback (CSF). In inactive UE SDT, the downlink response may be a msg4 in a RACH-based SDT or DCI that schedules a dynamic grant after an initial configured grant (CG) in CG-based SDT.

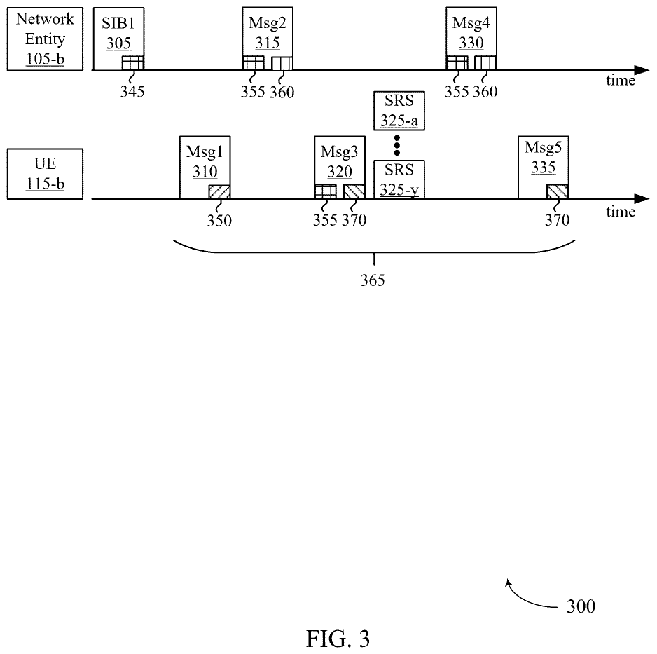

FIG. 3 shows an example of a signaling diagram 300 that supports early SRS capability signaling in accordance with one or more aspects of the present disclosure. The signaling diagram 300 may implement or may be implemented by aspects of the wireless communications system 100 or the process flow 200. For example, the signaling diagram 300 may include a UE 115-b, which may be an example of a UE 115 as described herein. The signaling diagram 300 may also include a network entity 105-b, which may be an example of a network entity 105 as described herein.

As described herein, the UE 115-b may transmit an initial RACH message such as the msg1 310 to initiate a RACH procedure 365 with the network entity 105-b. In some examples, the UE 115-b may receive SI, such as via a SIB1 305 prior to the initial RACH message (e.g., prior to the msg1 310). The UE 115-a may use information in the SIB1 305 to perform the RACH procedure 365. For example, the SIB1 305 may map ROs to SSBs, and the UE 115-b may select the RO in which to transmit the msg1 310 based on the mapping information in the SIB1 305 and measurements of SSBs received from the network entity 105-b. As described herein, the network entity 105-b may transmit a msg2 315 of the RACH procedure 365 in response to the msg1 310. The UE 115-b may transmit a msg3 320 of the RACH procedure 365 using a resource indicated by the msg2 315. The network entity 105-b may transmit a msg4 330 of the RACH procedure 365 in response to the msg3 320.

In some examples, as shown in the signaling diagram 300, the UE 115-b may be scheduled to transmit early SRSs 325. For example, the UE 115-b may be scheduled by the network entity 105-b to transmit early SRSs 325 using a Y-port (e.g., using a quantity Y ports) SRS resource set before completion of the RACH procedure 365 (e.g., before reception of a registration accept message that corresponds to the RACH procedure 365 such as the registration accept message at 240 described with reference to FIG. 2). For example, the msg2 315, the msg4 330, or a msg5 335 (also referred to as a msg4 ACK) of the RACH procedure 365 may include information 355 that triggers (e.g., schedules) the UE 115-b to transmit the early SRSs 325 (e.g., for a Y-port SRS resource set, SRS 325-a, . . . , SRS 325-y).

The network entity 105-b may derive an uplink and/or downlink precoder for initial access messages based on the early SRSs 325. For example, if the msg2 315 includes the information 355 that schedules the UE 115-b to transmit the early SRSs 325, the network entity 105-b may determine a downlink precoder for the msg4 330 and/or an uplink coder for the UE 115-b to apply to the msg5 335. The network entity 105-b may determine a downlink precoder if the early SRSs 325 are used for antenna switching. The network entity 105-b may determine an uplink precoder if the early SRSs 325 are used for CB based transmission. For idle UE RRC setup, the early SRSs 325 may be transmitted before msg4 if the information 355 that triggers the UE 115-b to transmit the early SRSs 325 is included in the msg2 315 or the msg3 320. For idle UE RRC setup, the early SRSs 325 may be transmitted before msg5 335 if the information 355 that triggers the UE 115-b to transmit the early SRSs 325 is included in the msg4 330, which is earlier than RRC reconfiguration (e.g., earlier than RRC reconfiguration at 245 as described with reference to FIG. 2). For inactive UE RRC resume, the early SRSs 325 may be transmitted before msg4 if the information 355 that triggers the UE 115-b to transmit the early SRSs 325 is included in the msg2 315 or the msg3 320, which is earlier than after msg5 335.

The UE 115-b may provide an indication of the SRS capability of the UE 115-b to enable configuration of the early SRSs (e.g., to enable the information 355 that triggers the UE 115-b to transmit the early SRSs 325 in accordance with an SRS configuration that is based on/in accordance with the SRS capability of the UE 115-b). For example, the UE 115-b may provide an indication 350 of the SRS capability of the UE 115-b before the message that triggers the early SRSs 325.

For example, the SRS capability of a UE 115, such as the UE 115-b, that may be indicated by a UE 115 (such as in the indication 350), may include one or more of the supported SRS time behavior (e.g., aperiodic, semi-persistent, periodic) and/or supported SRS type (e.g., antenna switching, CB, non-CB, BM). The SRS capability of the UE 115 may include, for each supported type and/or time behavior, and for each subcarrier spacing (SCS), BWP, component carrier (CC), or CCs in a band, band combination, feature set, feature set per band, and/or frequency range: the supported port number per resource, the maximum resource quantity per set, the maximum quantity set number, the maximum configured or activated spatial relations or transmission configuration indicator (TCI) states, the maximum quantity of simultaneously transmitted SRS resources, the max repetition quantity per SRS resource, the comb number, the supported SRS frequency hopping patterns (e.g., intra or inter-slot, partial frequency sounding, start resource block (RB) location hopping). For SRS antenna switching, the SRS capability of a UE 115 may include, for each supported type and/or time behavior, and for each SCS, BWP, CC, or CCs in a band, band combination, feature set, feature set per band, and/or frequency range: supported x Tx+y Rx configurations (e.g., “1T2R”, “1T4R”, “2T4R”, “1T4R/2T4R”, “1T=1R”, “2T=2R”, “4T=4R”); whether the uplink TX switching impacts downlink receiving in a band; whether the uplink transmission is switched together with uplink transmission in another band; and/or inter-cell/carrier switching time capability.

For aperiodic SRS, the SRS capability of a UE 115 may include, for each supported type and/or time behavior, and for each SCS, BWP, CC, or CCs in a band, band combination, feature set, feature set per band, and/or frequency range: the supported minimum triggering time offset (e.g., 0, 1, 2, in terms of symbols or slots) and/or the maximum quantity of configured available slots offsets for determining aperiodic SRS location based on available slot.

For CB or non-CB based SRS, the SRS capability of a UE 115 may include, for each supported type and/or time behavior, and for each SCS, BWP, CC, or CCs in a band, band combination, feature set, feature set per band, and/or frequency range: the maximum supported layer quantity, the demodulation reference signal (DMRS) type, and/or the DMRS pattern (e.g., time/frequency pattern per port). For non-CB based SRS, the SRS capability of a UE 115 may include, for each supported type and/or time behavior, and for each SCS, BWP, CC, or CCs in a band, band combination, feature set, feature set per band, and/or frequency range: support of association between CSI-RS and SRS resource sets, including the following sub capabilities: (1) a maximum quantity of periodic SRS resources associated with CSI-RS per BWP; (2) a maximum quantity of aperiodic SRS resources associated with CSI-RS per BWP; (3) a maximum quantity of semi-persistent SRS resources associated with CSI-RS per BWP; (4) whether the UE 115 can process Y SRS resources associated with CSI-RS resources simultaneously in a CC (e.g., includes periodic, aperiodic, and semi-persistent SRS); and/or (5) whether the UE 115 can process X SRS resources associated with CSI-RS resources simultaneously across all CCs.

The SRS capability of a UE 115 may include, for each supported type and/or time behavior, and for each SCS, BWP, CC, or CCs in a band, band combination, feature set, feature set per band, and/or frequency range: support of transmission of SRS for any combinations, including same type, of SRS based antenna switching and SRS for CB/non-CB/BM on different CCs in overlapped symbol(s) for intra-band or inter-band uplink carrier aggregation; and/or support of triggering SRS in DCI 0_1/0_2 without data and without CSI.

In some examples, the network entity 105-b may provide an indication 360 of a configuration for transmission of the early SRS 325 based on the indication 350 of the SRS capability of the UE 115-b. For example, the configuration may provide one or more parameters for the transmission of the early SRS 325. In some examples, the network entity 105-b may provide a rule for determining the parameters for the transmission of the early SRS 325. The one or more parameters provided by the configuration or determined according to the rule may include SRS time behavior (e.g., periodic, semi-persistent, or aperiodic). The one or more parameters provided by the configuration or determined according to the rule may include the quantity of SRS resource sets and/or the quantity of SRS resources per SRS resource set. The one or more parameters provided by the configuration or determined according to the rule may include, for each SRS resource per SRS resource set: a port number, a comb offset, a root sequence index, a cyclic shift, a total symbol quantity, a symbol repetition factor, symbol locations in the corresponding slot, an RB range, a frequency hopping pattern across different repetitions, a time/frequency location per repetition, a quasi co-location (QCL) source reference signal to determine the spatial transmission filter, a time offset from a reference downlink/uplink signal (e.g., Msg2 or Msg4 physical downlink control channel (PDCCH)/physical downlink shared channel (PDSCH), Msg1 or MsgA PRACH, Msg3 or MsgA PUSCH, triggering the early SRS 325). The one or more parameters provided by the configuration or determined according to the rule may include, for each, SRS resource set: timing advance information, SCS, power control parameters (e.g., P0, alpha, closed loop index, path loss reference signal), SRS resource set type (e.g., antenna switching, CB, non-CB, or BM).

In some examples, the UE 115-b may provide the indication 350 of the SRS capability of the UE 115-b via parameters related to physical RACH (PRACH) transmission for the initial RACH message (e.g., the msg1 310 in a 4-step RACH or a msgA in a 2-step RACH). For example, the PRACH parameters may include an RO index or time/frequency resource, a preamble index, a root sequence, SCS, and/or a repetition number. In such examples, dedicated sets of PRACH resources may be reserved (e.g., via SI such as the SIB1 305) for different candidate SRS UE capabilities, and the UE 115-b may use the PRACH parameters for the initial RACH message that corresponds to the SRS capability of the UE 115-b from among the different candidate SRS UE capabilities. Based on the indication 350 of the SRS capability of the UE 115-b in the initial RACH message (e.g., based on the PRACH parameters applied for the initial RACH message), the network entity 105-b may schedule transmission of the early SRSs 325 by indicating a corresponding SRS configuration that complies with the indicated SRS capability of the UE 115-b. For example, the network entity 105-b may include an indication 360 in the msg2 315 that indicates a corresponding SRS configuration that complies with the indicated SRS capability of the UE 115-b, and the UE 115-b may transmit the early SRSs 325 in accordance with the indicated configuration.

In some examples, the indication 360 of the SRS transmission configuration may be indicated in any initial access downlink message (e.g., the msg2 315 or the msg4 330). In some examples, the indication 360 of the SRS transmission configuration may include all of the parameters of the SRS transmission configuration (e.g., in a DCI message or a MAC control element (MAC-CE)). In some examples, the network entity 105-b may broadcast (e.g., via the SIB1 305, a MIB, or another SIB) an indication 345 of multiple candidate SRS transmission configurations containing at least a subset of SRS transmission parameters. In such examples, the indication 360 of the SRS transmission configuration may indicate a selected SRS transmission configuration from the multiple candidate SRS transmission configurations (e.g., based on an index where each of the candidate SRS transmission configurations are mapped to corresponding indices) and any remaining parameters for transmission of the early SRSs.

In some examples, the network entity 105-b may broadcast (e.g., via the SIB1 305, a MIB, or another SIB) an indication 345 of multiple candidate SRS transmission configurations containing at least a subset of SRS transmission parameters. In some such examples, the network entity 105-b or the UE 115-b may indicate information 355 that triggers the transmission of the early SRSs 325 in a message of the RACH procedure 365, and the UE 115-b may include an indication 370 of a selected SRS transmission configuration from the multiple candidate SRS transmission configurations in either the same message or a later message of the RACH procedure 365 as the message that includes the information 355 that triggers the early SRS transmission. For example, the message that includes the information 355 that triggers the early SRS transmission may be the msg2 315 or the msg4 330 (e.g., PDCCH or PDSCH), a msg3 320 or a msgA (e.g., a PUSCH), or the msg5 335 (e.g., a PUSCH), and the message that includes the indication 370 of the selected SRS transmission configuration from the multiple candidate SRS transmission configurations may be a msg3 320 or a msgA (e.g., a PUSCH), or the msg5 335 (e.g., a PUSCH). In some examples, some parameters associated with the SRS capability of the UE 115-b but not included in the selected SRS transmission configuration (as indicated by the indication 370) may also be dynamically indicated in the message that includes the information 355 that triggers the transmission of the early SRSs 325 or the message that includes the indication 370 of the selected SRS transmission configuration. Such parameters may include, for example, one or more of a time offset, a root sequence index, a cyclic shift, or comb offset. In some examples, the message that includes the information 355 that triggers the transmission of the early SRSs 325 may be extended to trigger one or multiple functions, and each function may include multiple candidate configurations based on different UE capabilities. In some examples, the functions may include SRS transmission and non-SRS transmission (e.g., CSI feedback). For example, multiple functions may be defined for different types of SRS transmission, including antenna switching, CB, non-CB, and BM, and which functions are triggered may be determined based on RRC signaling and/or the triggering message.

For example, the SIB1 305 may include an indication 345 of three types of early feedback, including: (1) CSF in the msg3 320, (2) CB based early SRS after msg3, and (3) antenna switching based early SRS after msg3. For each type of early feedback, the SIB1 may further configure four candidate configurations based on different UE capabilities. For example, for antenna switching based early SRS after msg3, the four candidate configurations based on different UE capabilities may be configured corresponding to 1T2R, 1T4R, 2T4R, and 4T4R. In some such examples, the msg2 315 may indicate which type of early feedback is triggered (e.g., antenna switching based early SRS, as well as the corresponding root sequence index, cyclic shift, and/or triggering slot offset, such as with respect to msg3). For example, the msg2 315 may include the information 355. The msg3 320 may include the indication 370 of the selected SRS transmission configuration based on the SRS capability of the UE 115-b. The UE 115-b may transmit the early SRSs 325 in accordance with the selected SRS transmission configuration, and the network entity 105-b may apply a derived downlink precoder to subsequent downlink messages (e.g., the msg4 330) based on measurements of the early SRSs 325.

In some examples, where the network entity 105-b may broadcast (e.g., via the SIB1 305, a MIB, or another SIB) an indication 345 of multiple candidate SRS transmission configurations, the UE 115-b may indicate the selected SRS transmission configuration implicitly via transmission of the early SRSs 325 in accordance with the selected SRS transmission configuration. For example, the network entity 105-b may detect the selected SRS transmission configuration based on reception of the early SRSs 325. In such examples, by implementation, the network entity 105-b may ensure that SRS transmissions may be differentiated (e.g., by assigning different root sequence index, cyclic shifts, symbol locations, and/or comb offsets to different candidate SRS transmission configurations).

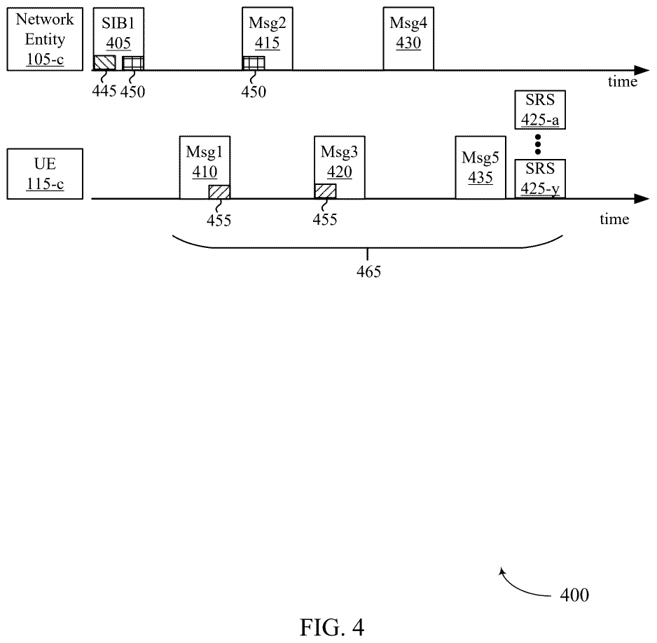

FIG. 4 shows an example of a signaling diagram 400 that supports early SRS capability signaling in accordance with one or more aspects of the present disclosure. The signaling diagram 400 may implement or may be implemented by aspects of the wireless communications system 100, the process flow 200, or the signaling diagram 300. For example, the signaling diagram 400 may include a UE 115-c, which may be an example of a UE 115 as described herein. The signaling diagram 400 may also include a network entity 105-c, which may be an example of a network entity 105 as described herein.

As described herein, the UE 115-c may transmit an initial RACH message such as the msg1 410 to initiate a RACH procedure 465 with the network entity 105-c. In some examples, the UE 115-c may receive SI, such as via a SIB1 405 prior to the initial RACH message (e.g., prior to the msg1 410). The UE 115-c may use information in the SIB1 405 to perform the RACH procedure 465. For example, the SIB1 405 may map ROs to SSBs, and the UE 115-c may select the RO in which to transmit the msg1 410 based on the mapping information in the SIB1 405 and measurements of SSBs received from the network entity 105-c. As described herein, the network entity 105-c may transmit a msg2 415 of the RACH procedure 465 in response to the msg1 410. The UE 115-c may transmit a msg3 420 of the RACH procedure 465 using a resource indicated by the msg3 415. The network entity 105-c may transmit a msg4 430 of the RACH procedure 465 in response to the msg3 420. The UE 115-c may transmit a msg5 435 to acknowledge reception of the msg4 430.

In some examples, as shown in the signaling diagram 400, the UE 115-c may be scheduled to transmit early SRSs 425. For example, the UE 115-c may be scheduled by the network entity 105-c to transmit early SRSs 425 using a Y-port (e.g., using a quantity Y ports) SRS resource set (e.g., for a Y-port SRS resource set, SRS 425-a, . . . , SRS 425-y) before completion of the RACH procedure 465 (e.g., before reception of a registration accept message that corresponds to the RACH procedure 465 such as the registration accept message at 240 described with reference to FIG. 2). The network entity 105-c may derive an uplink and/or downlink precoder for initial access messages based on the early SRSs 425.

In some examples, the network entity 105-c may send a request 450 for an indication of the SRS capability of the UE 115-c. In some examples, such a request may be standardized (e.g., may be a standard indication for the UE 115-c to provide in an initial access message) instead of being explicitly signaled. The UE 115-c may provide an indication 455 of the SRS capability of the UE 115-c in response to the request 450. For example, the request 450 or standards may list a set of capabilities and a corresponding reporting format. The request 450 may be standardized, broadcast (e.g., in SI such as SIB1 405, a MIB, or another SIB), and/or transmitted in an initial access message (such as in the msg2 415). The UE 115-c may provide the indication 455 based on the request 450 (e.g., the indication 455 may include the capabilities of the UE 115-c listed in the set of capabilities and/or in the requested format). The network entity 105-c may schedule the early SRSs 425 in accordance with an SRS transmission configuration that complies with the UE indicated SRS capability.

For example, the network entity 105-c may include the request 450 in the SIB1 405, where the request may list one or more candidate SRS transmission configurations for each of antenna switching based SRS, non-CB based SRS, and CB based SRS. The UE 115-c may include an indication 455 of whether each of the one or more candidate SRS transmission configurations is supported in msg1 410, msg4 420 (e.g., a PUSCH), or an msgA (e.g., an initial PRACH message in a 2-step RACH procedure). The network entity 105-c may subsequently trigger the early SRSs 425 in accordance with an SRS configuration that is supported by the UE 115-c as provided based on the indication 455.

In some examples, the SIB1 405 may include a list 445 of candidate SRS transmission configurations and corresponding indices. The request 450 in the msg2 415 may indicate one or more indices that correspond to one or more of the candidate SRS transmission configurations (e.g., a subset or all of the set of candidate SRS transmission configurations indicated in the SIB1 405), for example, via a bitmap, and the UE 115-c may respond in the msg3 420 with the indication 455 of which of the one or more of the candidate SRS transmission configurations indicated by the request 450 are supported by the UE 115-c.

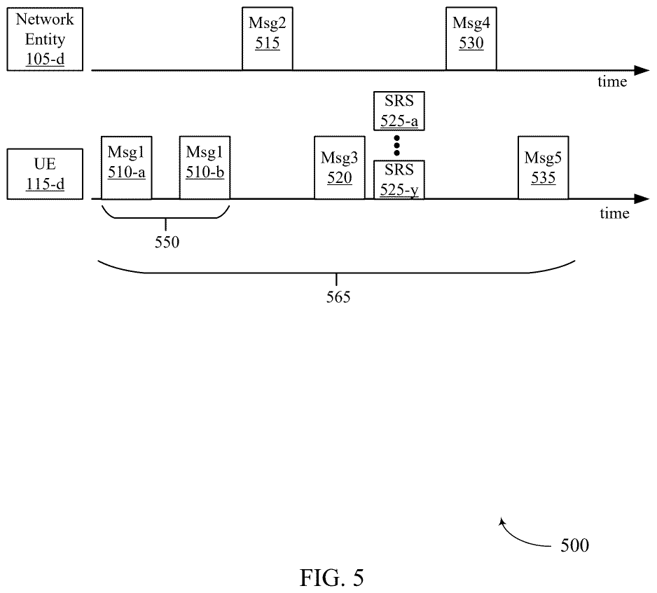

FIG. 5 shows an example of a signaling diagram 500 that supports early SRS capability signaling in accordance with one or more aspects of the present disclosure. The signaling diagram 500 may implement or may be implemented by aspects of the wireless communications system 100, the process flow 200, the signaling diagram 300, or the signaling diagram 400. For example, the signaling diagram 500 may include a UE 115-d, which may be an example of a UE 115 as described herein. The signaling diagram 500 may also include a network entity 105-d, which may be an example of a network entity 105 as described herein.

As described herein, the UE 115-d may transmit an initial RACH message such as the msg1 510 to initiate a RACH procedure 565 with the network entity 105-d. As described herein, the network entity 105-d may transmit a msg2 515 of the RACH procedure 565 in response to the msg1 510. The UE 115-d may transmit a msg3 520 of the RACH procedure 565 using a resource indicated by the msg2 515. The network entity may transmit a msg4 530 of the RACH procedure 565 in response to the msg3 520. The UE 115-d may transmit a msg5 535 to acknowledge reception of the msg4 530. In some examples, as shown in the signaling diagram 500, the UE 115-d may be scheduled to transmit early SRSs 525. For example, the UE 115-d may be scheduled by the network entity 105-d to transmit early SRSs 525 using a Y-port (e.g., using a quantity Y ports) SRS resource set (e.g., for a Y-port SRS resource set, SRS 525-a, . . . , SRS 525-y) before completion of the RACH procedure 565 (e.g., before reception of a registration accept message that corresponds to the RACH procedure 565 such as the registration accept message at 240 described with reference to FIG. 2). The network entity 105-d may derive an uplink and/or downlink precoder for initial access messages based on the early SRSs 525.

In some examples, the UE 115-d may indicate the SRS capability of the UE 115-d based on an enhanced msg1 550, which may have two parts (e.g., a first part msg1 510-a and a second part msg1 510-b). For example, the SRS capability of the UE 115-d may be indicated by a combination of any parameters associated with the two parts of the enhanced msg1 550 (e.g., RO time/frequency resource, root sequence ID, preamble ID). As an example, the preamble ID offsets X, Y, and Z (e.g., between the first part msg1 510-a and the second part msg1 510-b) may indicate support of antenna switching based SRS only, CB based SRS only, and both, respectively. In some examples, mapping of parameters of the enhanced msg1 550 to different SRS capabilities of the UE 115-d may be indicated in a broadcast message from the network entity 105-d, such as in SI. Based on the indication of the SRS capability of the UE 115-d by the parameters of the enhanced msg1 550, the network entity 105-d may schedule transmission of the early SRSs 525 in accordance with a configuration that complies with the SRS capability of the UE 115-d.

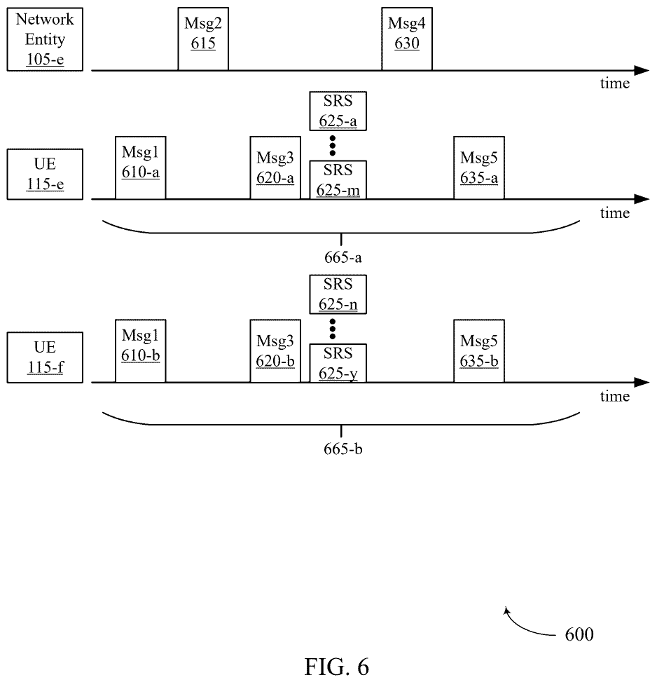

FIG. 6 shows an example of a signaling diagram 600 that supports early SRS capability signaling in accordance with one or more aspects of the present disclosure. The signaling diagram 600 may implement or may be implemented by aspects of the wireless communications system 100, the process flow 200, the signaling diagram 300, the signaling diagram 400, or the signaling diagram 500. For example, the signaling diagram 600 may include a UE 115-e and a UE 115-f, which may be examples of UEs 115 as described herein. The signaling diagram 600 may also include a network entity 105-e, which may be an example of a network entity 105 as described herein.

As described herein, the UE 115-e may transmit an initial RACH message such as the msg1 610-a to initiate a RACH procedure 665-a with the network entity 105-e. The UE 115-f may also transmit an initial RACH message such as the msg1 610-b to initiate a RACH procedure 665-b with the network entity 105-e in the same RO as the UE 115-e transmitted the msg1 610-a (e.g., in contention based random access). Accordingly, the msg1 610-a and the msg1 610-b may collide if the msg1 610-a and the msg1 610-b use the same preamble sequence. The network entity 105-e may transmit a msg2 615 in response to the msg1 610-a and/or the msg1 610-b. The UE 115-e may transmit a msg3 620-a using a resource indicated by the msg2 615, and the UE 115-f may transmit a msg3 620-b using a resource indicated by the msg2 615. The UE 115-e and the UE 115-f may transmit respective early SRSs 625 (e.g., the UE 115-e may transmit early SRS 625-a through early SRS 625-m and the UE 115-f may transmit early SRSs 625-n through early SRS 625-y) in the same resources and potentially using the same SRS sequence. If the network entity 105-e decodes one of the msg3s 620 and sends a msg4 630 that selects one of the UEs 115 based on the decoded msg3 620, the corresponding channel measurements based on the early SRSs 625 may be corrupted based on the collisions between the early SRSs 625. The UE 115-e may transmit a msg5 635-a to acknowledge reception of the msg4 630 and/or the UE 115-f may transmit a msg5 635-b to acknowledge reception of the msg4 630. The network entity 105-e may be unaware of the collision between the early SRSs 625. Precoding based on corrupted or inaccurate measurements of SRSs may result in worse performance than no precoding.

Accordingly, to reduce the chance of collision between the early SRSs 625 transmitted by the UE 115-e and the UE 115-f, each of the UE 115-e and the UE 115-f may randomly select one or more SRS transmission parameters (e.g., any of the parameters of an SRS transmission configuration as described herein). For example, the UE 115-e and the UE 115-f may each randomly select one or more of a root sequence index, a cyclic shift, and/or a comb offset to apply to the respective early SRSs 625. In some examples, the UEs 115 may indicate the selected parameters in one of the RACH messages (e.g., in msg1 610 or msg3 620). In some examples, the network entity 105-e may indicate which SRS transmission parameters the UEs 115 are allowed to randomly select (e.g., in SI, in an SRS triggering message such as msg2 615 or msg4 630), for example, based on the detection of a potential msg1 collision by the network entity 105-e. In some examples, which SRS transmission parameters the UEs 115 are allowed to randomly select may be predefined or standardized. In some examples, dedicated MAC-CEs, DCI, or uplink control information may be used to carry the allowed and randomly selected SRS transmission parameters.

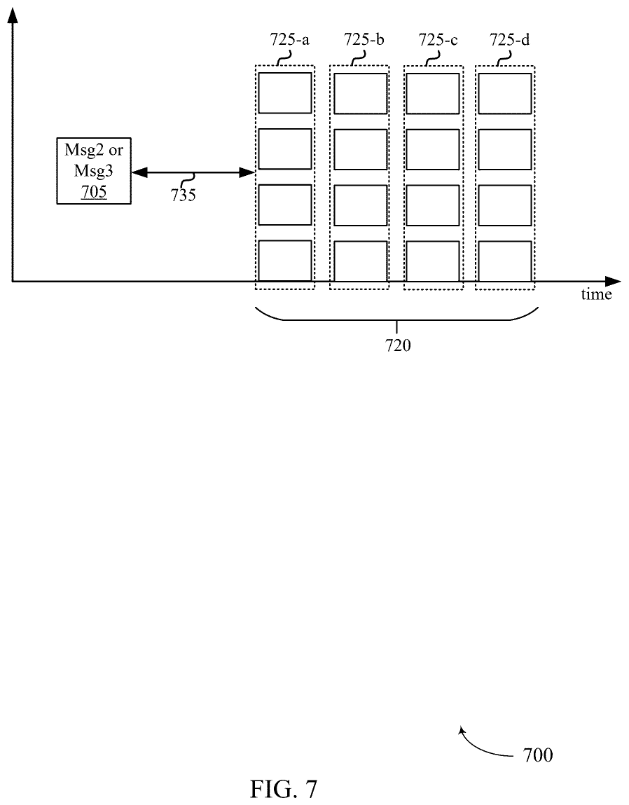

FIG. 7 shows an example of a timing diagram 700 that supports early SRS capability signaling in accordance with one or more aspects of the present disclosure. The timing diagram 700 may implement or may be implemented by aspects of the wireless communications system 100, the process flow 200, the signaling diagram 300, the signaling diagram 400, the signaling diagram 500, or the signaling diagram 600.

As described herein, an SRS transmission configuration for early SRS may include a time offset 735 for an SRS resource set 720. For example, for an SRS resource set 720 that includes four 1-port SRS resources 725 (e.g., a first 1-port SRS resources 725-a, a second 1-port SRS resources 725-b, a third 1-port SRS resources 725-c, and third a 1-port SRS resources 725-d) the offset 735 may indicate a duration between the message 705 (such as an msg2 or an msg3) that triggers the early SRS transmission in the SRS resource set 720 and the first 1-port SRS resources 725-a of the SRS resource set 720.

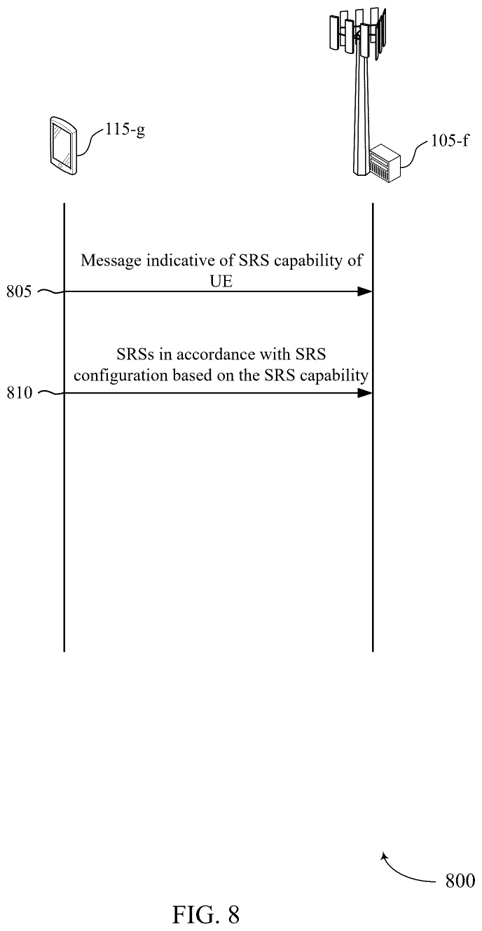

FIG. 8 shows an example of a process flow 800 that supports early SRS capability signaling in accordance with one or more aspects of the present disclosure. The process flow 800 may implement or may be implemented by aspects of the wireless communications system 100, the process flow 200, the signaling diagram 300, the signaling diagram 300, the signaling diagram 400, the signaling diagram 500, the signaling diagram 600, or the timing diagram 700. For example, the process flow 800 may include a UE 115-g, which may be an example of a UE 115 as described herein. The process flow 800 may also include a network entity 105-f, which may be an example of a network entity 105 as described herein. In the following description of the process flow 800, the communications between the network entity 105-f and the UE 115-g may be transmitted in a different order than the example order shown, or the operations performed by the network entity 105-f and the UE 115-g may be performed in different orders or at different times. Some operations may also be omitted from the process flow 800, and other operations may be added to the process flow 800.

At 805, the UE 115-g may transmit a message to the network entity 105-f. The message or transmission of the message may be indicative of an SRS capability supported by the UE 115-g. The SRS capability may be associated with early SRS transmission, where the early SRS transmission is after initiation by the UE 115-g of a RACH procedure with the network entity 105-f and prior to reception by the UE 115-g of a corresponding registration acceptance message from the network entity 105-f associated with the RACH procedure.

At 810, the UE 115-g may transmit, and the network entity 105-f may receive, a set of SRSs in accordance with an SRS configuration that is based on the SRS capability.

In some examples, the message is an initial message (e.g., a msg1 or an msgA) of the RACH procedure, and the message includes an indication of the SRS capability. In some such examples, the indication in the initial message indicates the SRS capability from a set of multiple candidate SRS capabilities based on a RO via which the initial message is transmitted or a transmission parameter of the initial message (e.g., a PRACH parameter of the initial message), and the set of multiple candidate SRS capabilities are mapped to different RO or different transmission parameters. In some examples, the UE 115-g may receive, from the network entity 105-f and based on the initial message, a second message of the RACH procedure (e.g., a msgB, a msg2, a msg4) that triggers the set of SRSs and indicates the SRS configuration for the set of SRSs. In some examples, the UE 115-g may receive, from the network entity 105-f, SI that indicates a set of multiple indices associated with respective SRS configurations. In such examples, the UE 115-g may receive, from the network entity 105-f and based on the initial message, a second message of the RACH procedure (e.g., a msgB, a msg2, a msg4) that triggers the set of SRSs and indicates an index from the set of multiple indices, where the index indicates selection of the SRS configuration.

In some examples, the UE 115-g may receive, from the network entity 105-f, SI that indicates a set of multiple SRS capabilities, and the set of multiple SRS capabilities includes the SRS capability indicated at 805. In some examples, the message is a random access message of the RACH procedure (e.g., a msg1, a msgA, a msg3), the message includes an indication of the SRS capability, and the message indicates one or more SRS transmission parameters in addition to the SRS capability. In some examples, transmitting the message at 805 may include transmitting the set of SRSs in accordance with the SRS capability (e.g., transmission of the message may be transmission of the SRSs and transmission of the message may indicate the SRS capability).

In some examples, the UE 115-g may receive, from the network entity 105-f, a request for SRS capability information from the UE 115-g, and transmission of the message at 805 may be based on the request. In some examples, the request may be received in SI. In some examples, the UE 115-g may transmit, to the network entity 105-f, an initial message of the RACH procedure. In some such examples, the UE 115-g may receive, from the network entity 105-f, a second message of the RACH procedure based on the initial message, where the second message includes the request. In some examples, the UE 115-g may transmit, to the network entity 105-f, a third message of the RACH procedure, where the third message is the message at 805.

In some examples, the message at 805 may be based on an enhanced msg1 as described herein. For example, transmitting the message at 805 may include: transmitting a first initial access message of the RACH procedure via a first RO and in accordance with a first set of transmission parameters; and transmitting a second initial access message of the RACH procedure via a second RO and in accordance with a second set of transmission parameters. In such examples, the message may be indicative of the SRS capability at least in part on an offset between the first RO and the second RO, the first set of transmission parameters, the second set of transmission parameters, or any combination thereof.

In some examples, the message at 805 may be indicative of the SRS capability based on satisfaction of a triggering condition associated with the SRS capability. For example, the network entity 10-f or the UE 115-g may select a given SRS transmission configuration when additional condition(s) are satisfied. As an example, some configurations supporting enhanced coverage may be selected only when the UE 115-g is in poor coverage, which can be identified by the PRACH repetition number, or the selected SSB reference signal received power (RSRP) is below a configured threshold. For example, some configurations supporting enhanced coverage may include more SRS symbols per resource, intra or inter-frequency SRS hopping patterns. Such additional conditions may be predefined, standardized, or indicated by the network entity 105-f (e.g., in a broadcast message such as SI).

In some examples, the UE 115-g may transmit, to the network entity 105-f, prior to the reception by the UE 115-g of the corresponding registration acceptance message from the network entity 105-f, an indication of one or more additional operating parameters of the UE 115-g. For example, the UE 115-g may indicate in addition to support of early SRS transmission, support of an early CSI report (e.g., based on type1 or type2 CSI codebook), where an early CSI report is prior to the reception by the UE 115-g of the corresponding registration acceptance message from the network entity 105-f. As another example, the UE 115-g may indicate supported uplink waveform types (e.g., cyclic prefix OFDM, DFT-S, and/or dynamic switching between waveform types). As another example, the UE 115-g may indicate supported access message repetitions (e.g., PDCCH for Msg2, Msg4, MsgB, Msg5, PDSCH for Msg2, Msg4, physical uplink control channel (PUCCH) for Msg4, MsgB, PUSCH for Msg3, Msg5, MsgA, PRACH for Msg1).

In some examples, the transmit power of the SRSs at 810 may be determined by the UE 115-g via an implicit rule (e.g., based on the same power or power density as a co-scheduled Msg3).

In some examples, the UE 115-g may randomly select a root sequence index, a cyclic shift, a comb offset, or a combination thereof to apply to transmission of the set of SRSs. In some such examples, the UE 115-g may transmit, to the network entity 105-f, a message that indicates the root sequence index, the cyclic shift, the comb offset, or the combination thereof.

In some examples, the SRS capability includes one or more of: SRS scheduling type capability information, SRS type capability information, antenna port information; SRS antenna switching capability information, aperiodic SRS offset capability information, PUSCH capability information, or SRS triggering capability information.

In some examples, the UE 115-g may receive, from the network entity 105-f and based on the message, a second message that indicates the SRS configuration, where the SRS configuration includes: a scheduling type of the set of SRSs, a quantity of resource sets associated with the set of SRSs, a quantity of resources per resource set of the quantity of resource sets, antenna port information, comb offset information, a root sequence, a cyclic shift, frequency hopping information, repetition information, spatial filter information, time offset information, transmission power control information, or codebook type information.

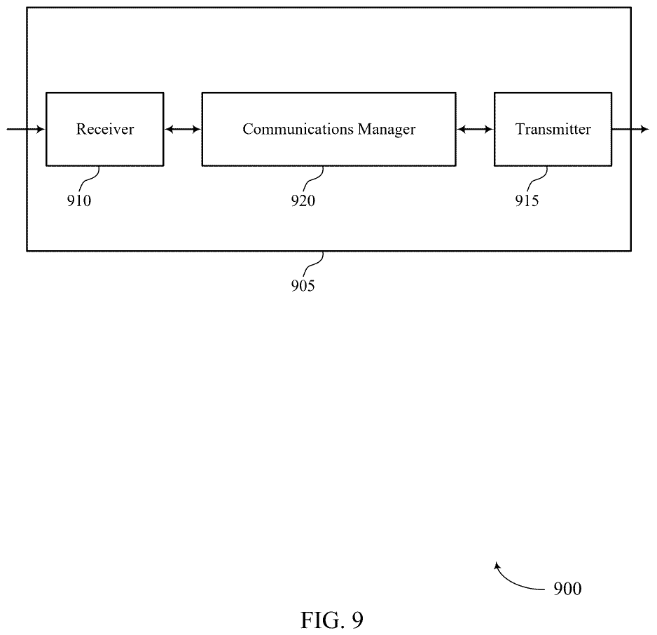

FIG. 9 shows a block diagram 900 of a device 905 that supports early SRS capability signaling in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to early SRS capability signaling). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to early SRS capability signaling). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of early SRS capability signaling as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting a message to a network entity, where the message or transmission of the message is indicative of an SRS capability supported by the UE, where the SRS capability is associated with early SRS transmission, where the early SRS transmission is after initiation by the UE of a RACH procedure with the network entity and prior to reception by the UE of a corresponding registration acceptance message from the network entity associated with the RACH procedure. The communications manager 920 is capable of, configured to, or operable to support a means for transmitting a set of SRSs in accordance with an SRS configuration that is based on the SRS capability.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

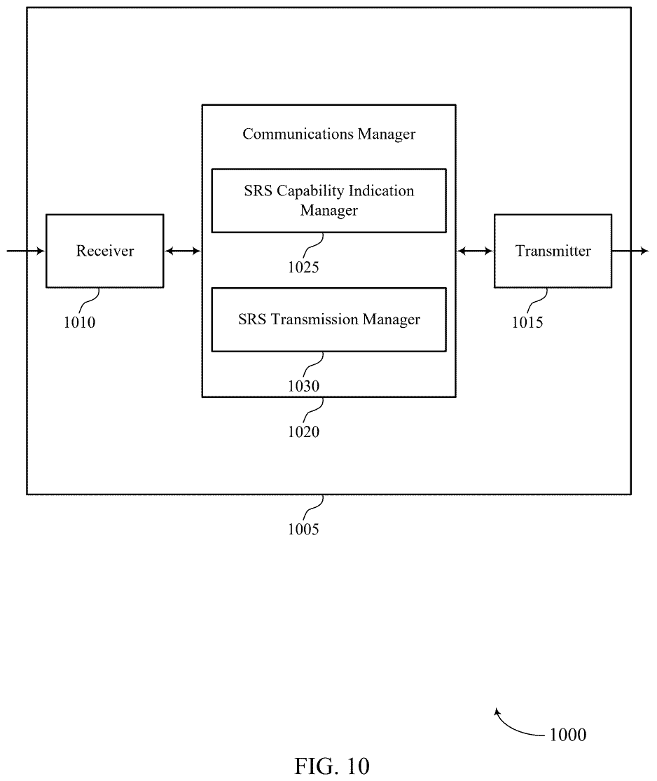

FIG. 10 shows a block diagram 1000 of a device 1005 that supports early SRS capability signaling in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to early SRS capability signaling). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to early SRS capability signaling). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of early SRS capability signaling as described herein. For example, the communications manager 1020 may include an SRS capability indication manager 1025 an SRS transmission manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The SRS capability indication manager 1025 is capable of, configured to, or operable to support a means for transmitting a message to a network entity, where the message or transmission of the message is indicative of an SRS capability supported by the UE, where the SRS capability is associated with early SRS transmission, where the early SRS transmission is after initiation by the UE of a RACH procedure with the network entity and prior to reception by the UE of a corresponding registration acceptance message from the network entity associated with the RACH procedure. The SRS transmission manager 1030 is capable of, configured to, or operable to support a means for transmitting a set of SRSs in accordance with an SRS configuration that is based on the SRS capability.

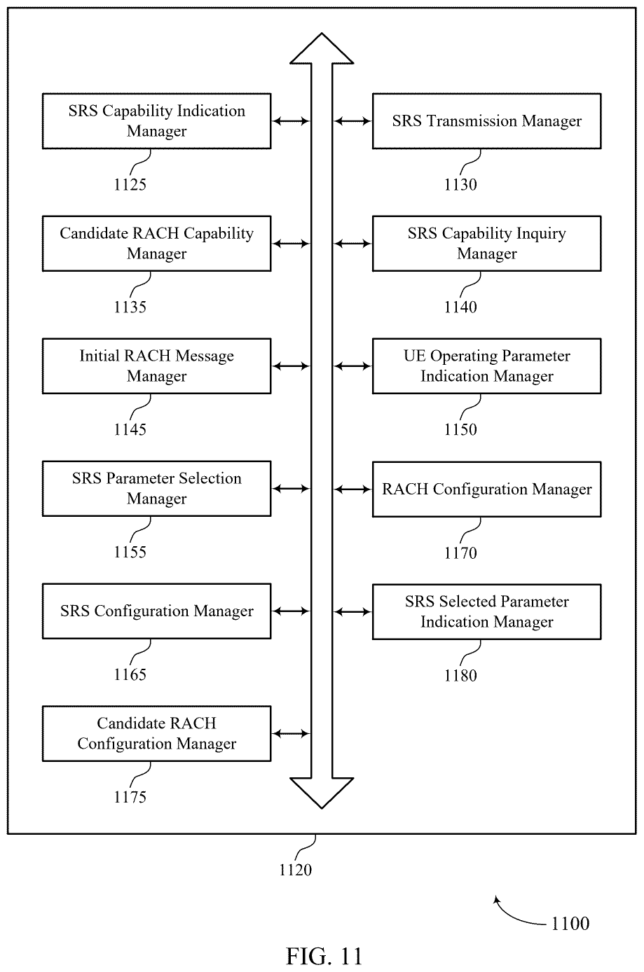

FIG. 11 shows a block diagram 1100 of a communications manager 1120 that supports early SRS capability signaling in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of early SRS capability signaling as described herein. For example, the communications manager 1120 may include an SRS capability indication manager 1125, an SRS transmission manager 1130, a candidate RACH capability manager 1135, an SRS capability inquiry manager 1140, an initial RACH message manager 1145, a UE operating parameter indication manager 1150, an SRS parameter selection manager 1155, an SRS configuration manager 1165, a RACH configuration manager 1170, a candidate RACH configuration manager 1175, an SRS selected parameter indication manager 1180, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The SRS capability indication manager 1125 is capable of, configured to, or operable to support a means for transmitting a message to a network entity, where the message or transmission of the message is indicative of an SRS capability supported by the UE, where the SRS capability is associated with early SRS transmission, where the early SRS transmission is after initiation by the UE of a RACH procedure with the network entity and prior to reception by the UE of a corresponding registration acceptance message from the network entity associated with the RACH procedure. The SRS transmission manager 1130 is capable of, configured to, or operable to support a means for transmitting a set of SRSs in accordance with an SRS configuration that is based on the SRS capability.

In some examples, the message is an initial message of the RACH procedure. In some examples, the message includes an indication of the SRS capability.

In some examples, the indication in the initial message indicates the SRS capability from a set of multiple candidate SRS capabilities based on a RO via which the initial message is transmitted or a transmission parameter of the initial message. In some examples, the set of multiple candidate SRS capabilities are mapped to different RO or different transmission parameters.

In some examples, the RACH configuration manager 1170 is capable of, configured to, or operable to support a means for receiving, from the network entity and based on the initial message, a second message of the RACH procedure that triggers the set of SRSs and indicates the SRS configuration for the set of SRSs.

In some examples, the candidate RACH configuration manager 1175 is capable of, configured to, or operable to support a means for receiving, from the network entity, SI that indicates a set of multiple indices associated with respective SRS configurations. In some examples, the RACH configuration manager 1170 is capable of, configured to, or operable to support a means for receiving, from the network entity and based on the initial message, a second message of the RACH procedure that triggers the set of SRSs and indicates an index from the set of multiple indices, where the index indicates selection of the SRS configuration.

In some examples, the candidate RACH capability manager 1135 is capable of, configured to, or operable to support a means for receiving, from the network entity, SI that indicates a set of multiple SRS capabilities, where the set of multiple SRS capabilities includes the SRS capability.

In some examples, the message is a random access message of the RACH procedure. In some examples, the message includes an indication of the SRS capability. In some examples, the message indicates one or more SRS transmission parameters in addition to the SRS capability.

In some examples, to support transmitting the message, the SRS transmission manager 1130 is capable of, configured to, or operable to support a means for transmitting the set of SRSs in accordance with the SRS capability.

In some examples, the SRS capability inquiry manager 1140 is capable of, configured to, or operable to support a means for receiving, from the network entity, a request for SRS capability information from the UE, where transmission of the message is based on the request.

In some examples, to support receiving the request, the SRS capability inquiry manager 1140 is capable of, configured to, or operable to support a means for receiving the request via SI.

In some examples, the initial RACH message manager 1145 is capable of, configured to, or operable to support a means for transmitting an initial message of the RACH procedure. In some examples, the SRS capability inquiry manager 1140 is capable of, configured to, or operable to support a means for receiving, from the network entity, a second message of the RACH procedure based on the initial message, where the second message includes the request. In some examples, the SRS capability indication manager 1125 is capable of, configured to, or operable to support a means for transmitting, to the network entity and based on the request, a third message of the RACH procedure, where the third message is the message.

In some examples, to support transmitting the message, the initial RACH message manager 1145 is capable of, configured to, or operable to support a means for transmitting a first initial access message of the RACH procedure via a first RO and in accordance with a first set of transmission parameters. In some examples, to support transmitting the message, the initial RACH message manager 1145 is capable of, configured to, or operable to support a means for transmitting a second initial access message of the RACH procedure via a second RO and in accordance with a second set of transmission parameters, where the message is indicative of the SRS capability at least in part on an offset between the first RO and the second RO, the first set of transmission parameters, the second set of transmission parameters, or any combination thereof.

In some examples, the message is indicative of the SRS capability based on satisfaction of a triggering condition associated with the SRS capability.

In some examples, the UE operating parameter indication manager 1150 is capable of, configured to, or operable to support a means for transmitting, prior to the reception by the UE of the corresponding registration acceptance message from the network entity, an indication of one or more additional operating parameters of the UE.

In some examples, the SRS parameter selection manager 1155 is capable of, configured to, or operable to support a means for randomly selecting a root sequence index, a cyclic shift, a comb offset, or a combination thereof to apply to transmission of the set of SRSs.

In some examples, the SRS selected parameter indication manager 1180 is capable of, configured to, or operable to support a means for transmitting a second message to the network entity that indicates the root sequence index, the cyclic shift, the comb offset, or the combination thereof.

In some examples, the SRS capability includes one or more of: SRS scheduling type capability information, SRS type capability information, antenna port information; SRS antenna switching capability information, aperiodic SRS offset capability information, PUSCH capability information, or SRS triggering capability information.

In some examples, the SRS configuration manager 1165 is capable of, configured to, or operable to support a means for receiving, from the network entity and based on the message, a second message that indicates the SRS configuration, where the SRS configuration includes: a scheduling type of the set of SRSs, a quantity of resource sets associated with the set of SRSs, a quantity of resources per resource set of the quantity of resource sets, antenna port information, comb offset information, a root sequence, a cyclic shift, frequency hopping information, repetition information, spatial filter information, time offset information, transmission power control information, or codebook type information.

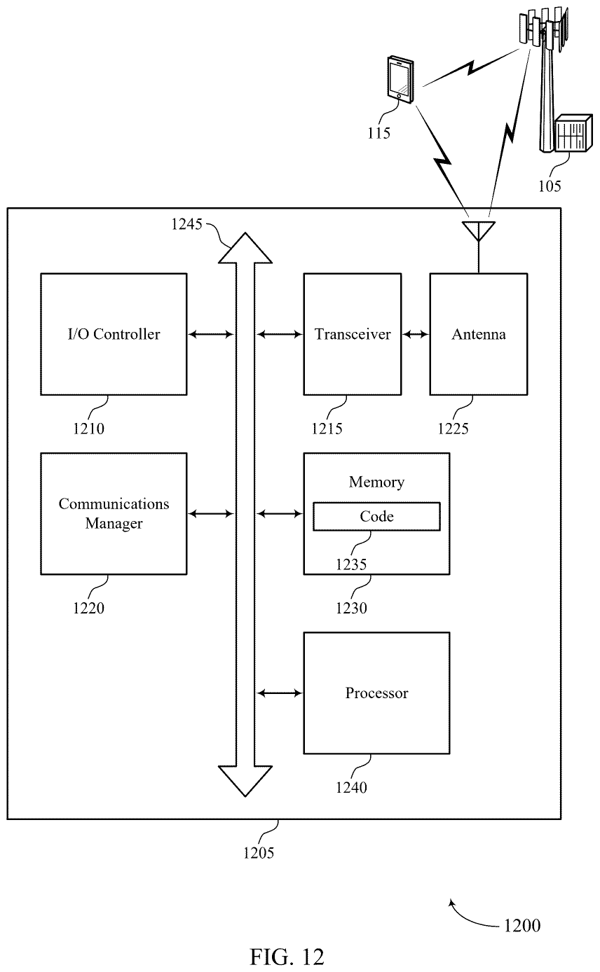

FIG. 12 shows a diagram of a system 1200 including a device 1205 that supports early SRS capability signaling in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting early SRS capability signaling). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for transmitting a message to a network entity, where the message or transmission of the message is indicative of an SRS capability supported by the UE, where the SRS capability is associated with early SRS transmission, where the early SRS transmission is after initiation by the UE of a RACH procedure with the network entity and prior to reception by the UE of a corresponding registration acceptance message from the network entity associated with the RACH procedure. The communications manager 1220 is capable of, configured to, or operable to support a means for transmitting a set of SRSs in accordance with an SRS configuration that is based on the SRS capability.

By including or configuring the communications manager 1220 in accordance with examples as described herein, the device 1205 may support techniques for reduced latency, more efficient utilization of communication resources, and improved coordination between devices.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of early SRS capability signaling as described herein, or the at least one processor 1240 and the at least one memory 1230 may be otherwise configured to, individually or collectively, perform or support such operations.

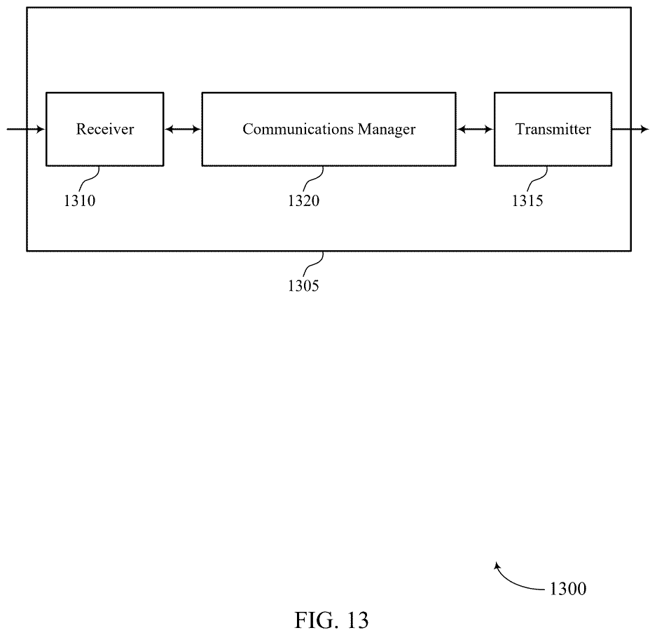

FIG. 13 shows a block diagram 1300 of a device 1305 that supports early SRS capability signaling in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of early SRS capability signaling as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for receiving a message from a UE, where the message or reception of the message is indicative of an SRS capability supported by the UE, where the SRS capability is associated with early SRS transmission, where the early SRS transmission is after initiation by the UE of a RACH procedure with the network entity and prior to transmission by the network entity of a corresponding registration acceptance message to the UE associated with the RACH procedure. The communications manager 1320 is capable of, configured to, or operable to support a means for receiving, from the UE, a set of SRSs in accordance with an SRS configuration that is based on the SRS capability.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for more efficient utilization of communication resources.

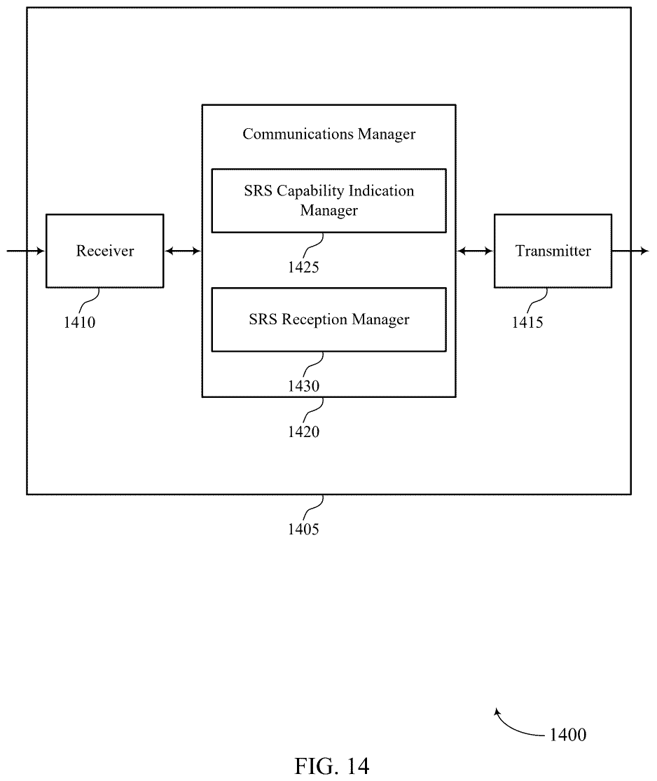

FIG. 14 shows a block diagram 1400 of a device 1405 that supports early SRS capability signaling in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of early SRS capability signaling as described herein. For example, the communications manager 1420 may include an SRS capability indication manager 1425 an SRS reception manager 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The SRS capability indication manager 1425 is capable of, configured to, or operable to support a means for receiving a message from a UE, where the message or reception of the message is indicative of an SRS capability supported by the UE, where the SRS capability is associated with early SRS transmission, where the early SRS transmission is after initiation by the UE of a RACH procedure with the network entity and prior to transmission by the network entity of a corresponding registration acceptance message to the UE associated with the RACH procedure. The SRS reception manager 1430 is capable of, configured to, or operable to support a means for receiving, from the UE, a set of SRSs in accordance with an SRS configuration that is based on the SRS capability.

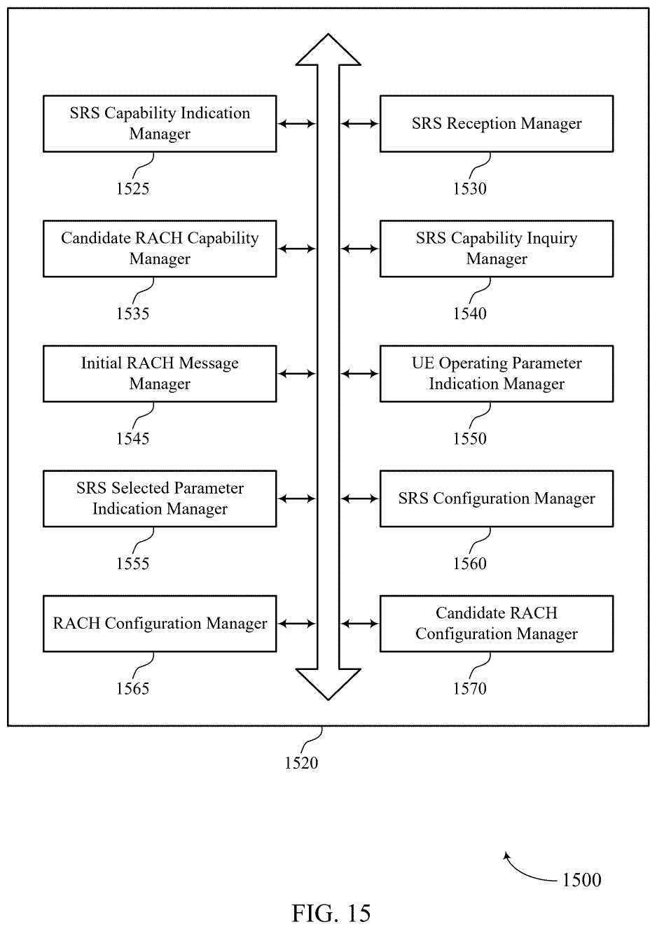

FIG. 15 shows a block diagram 1500 of a communications manager 1520 that supports early SRS capability signaling in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of early SRS capability signaling as described herein. For example, the communications manager 1520 may include an SRS capability indication manager 1525, an SRS reception manager 1530, a candidate RACH capability manager 1535, an SRS capability inquiry manager 1540, an initial RACH message manager 1545, a UE operating parameter indication manager 1550, an SRS selected parameter indication manager 1555, an SRS configuration manager 1560, a RACH configuration manager 1565, a candidate RACH configuration manager 1570, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The SRS capability indication manager 1525 is capable of, configured to, or operable to support a means for receiving a message from a UE, where the message or reception of the message is indicative of an SRS capability supported by the UE, where the SRS capability is associated with early SRS transmission, where the early SRS transmission is after initiation by the UE of a RACH procedure with the network entity and prior to transmission by the network entity of a corresponding registration acceptance message to the UE associated with the RACH procedure. The SRS reception manager 1530 is capable of, configured to, or operable to support a means for receiving, from the UE, a set of SRSs in accordance with an SRS configuration that is based on the SRS capability.

In some examples, the message is an initial message of the RACH procedure. In some examples, the message includes an indication of the SRS capability.

In some examples, the indication in the initial message indicates the SRS capability from a set of multiple candidate SRS capabilities based on a RO via which the initial message is transmitted or a transmission parameter of the initial message. In some examples, the set of multiple candidate SRS capabilities are mapped to different RO or different transmission parameters.

In some examples, the RACH configuration manager 1565 is capable of, configured to, or operable to support a means for transmitting, to the UE and based on the initial message, a second message of the RACH procedure that triggers the set of SRSs and indicates the SRS configuration for the set of SRSs.

In some examples, the candidate RACH configuration manager 1570 is capable of, configured to, or operable to support a means for transmitting SI that indicates a set of multiple indices associated with respective SRS configurations. In some examples, the RACH configuration manager 1565 is capable of, configured to, or operable to support a means for transmitting, to the UE and based on the initial message, a second message of the RACH procedure that triggers the set of SRSs and indicates an index from the set of multiple indices, where the index indicates selection of the SRS configuration.

In some examples, the candidate RACH capability manager 1535 is capable of, configured to, or operable to support a means for transmitting SI that indicates a set of multiple SRS capabilities, where the set of multiple SRS capabilities includes the SRS capability.

In some examples, the message is a random access message of the RACH procedure. In some examples, the message includes an indication of the SRS capability. In some examples, the message indicates one or more SRS transmission parameters in addition to the SRS capability.

In some examples, to support receiving the message, the SRS reception manager 1530 is capable of, configured to, or operable to support a means for receiving the set of SRSs in accordance with the SRS capability.

In some examples, the SRS capability inquiry manager 1540 is capable of, configured to, or operable to support a means for transmitting, to the UE, a request for SRS capability information from the UE, where transmission of the message is based on the request.

In some examples, to support transmitting the request, the SRS capability inquiry manager 1540 is capable of, configured to, or operable to support a means for transmitting the request via SI.

In some examples, the initial RACH message manager 1545 is capable of, configured to, or operable to support a means for receiving, from the UE, an initial message of the RACH procedure. In some examples, the SRS capability inquiry manager 1540 is capable of, configured to, or operable to support a means for transmitting, to the UE, a second message of the RACH procedure based on the initial message, where the second message includes the request. In some examples, the SRS capability indication manager 1525 is capable of, configured to, or operable to support a means for receiving, from the UE and based on the request, a third message of the RACH procedure, where the third message is the message.

In some examples, to support receiving the message, the initial RACH message manager 1545 is capable of, configured to, or operable to support a means for receiving, from the UE, a first initial access message of the RACH procedure via a first RO and in accordance with a first set of transmission parameters. In some examples, to support receiving the message, the initial RACH message manager 1545 is capable of, configured to, or operable to support a means for receiving, from the UE, a second initial access message of the RACH procedure via a second RO and in accordance with a second set of transmission parameters, where the message is indicative of the SRS capability at least in part on an offset between the first RO and the second RO, the first set of transmission parameters, the second set of transmission parameters, or any combination thereof.

In some examples, the message is indicative of the SRS capability based on satisfaction of a triggering condition associated with the SRS capability.

In some examples, the UE operating parameter indication manager 1550 is capable of, configured to, or operable to support a means for receiving, from the UE and prior to the transmission of the corresponding registration acceptance message from the network entity, an indication of one or more additional operating parameters of the UE.

In some examples, the SRS selected parameter indication manager 1555 is capable of, configured to, or operable to support a means for receiving, from the UE, a second message that indicates a root sequence index, a cyclic shift, a comb offset, or a combination thereof that is applied to the set of SRSs.

In some examples, the SRS capability includes one or more of: SRS scheduling type capability information, SRS type capability information, antenna port information; SRS antenna switching capability information, aperiodic SRS offset capability information, PUSCH capability information, or SRS triggering capability information.

In some examples, the SRS configuration manager 1560 is capable of, configured to, or operable to support a means for transmitting, to the UE and based on the message, a second message that indicates the SRS configuration, where the SRS configuration includes: a scheduling type of the set of SRSs, a quantity of resource sets associated with the set of SRSs, a quantity of resources per resource set of the quantity of resource sets, antenna port information, comb offset information, a root sequence, a cyclic shift, frequency hopping information, repetition information, spatial filter information, time offset information, transmission power control information, or codebook type information.

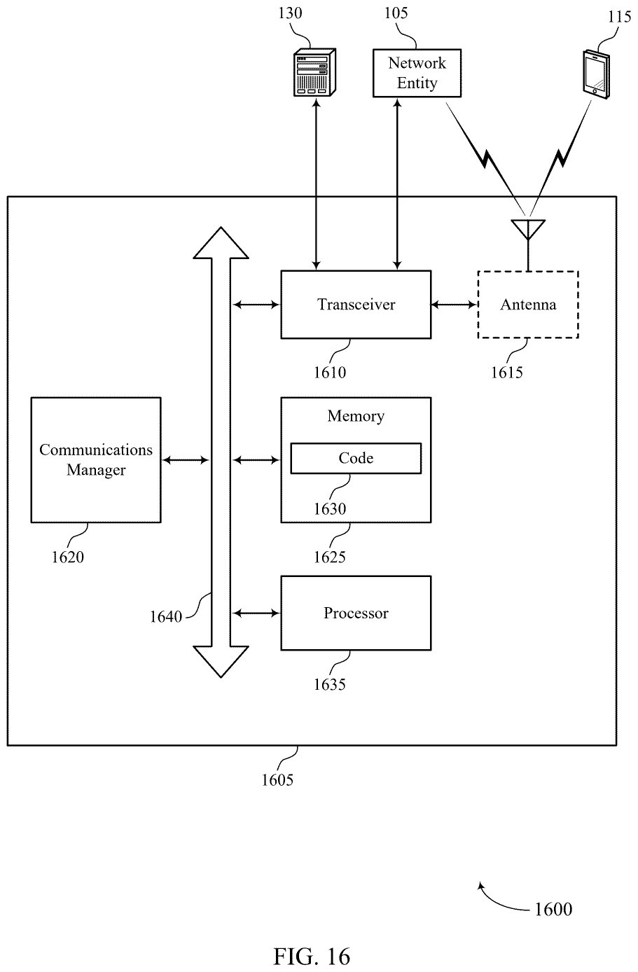

FIG. 16 shows a diagram of a system 1600 including a device 1605 that supports early SRS capability signaling in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting early SRS capability signaling). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network entities 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for receiving a message from a UE, where the message or reception of the message is indicative of an SRS capability supported by the UE, where the SRS capability is associated with early SRS transmission, where the early SRS transmission is after initiation by the UE of a RACH procedure with the network entity and prior to transmission by the network entity of a corresponding registration acceptance message to the UE associated with the RACH procedure. The communications manager 1620 is capable of, configured to, or operable to support a means for receiving, from the UE, a set of SRSs in accordance with an SRS configuration that is based on the SRS capability.

By including or configuring the communications manager 1620 in accordance with examples as described herein, the device 1605 may support techniques for reduced latency, more efficient utilization of communication resources, and improved coordination between devices.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of early SRS capability signaling as described herein, or the at least one processor 1635 and the at least one memory 1625 may be otherwise configured to, individually or collectively, perform or support such operations.

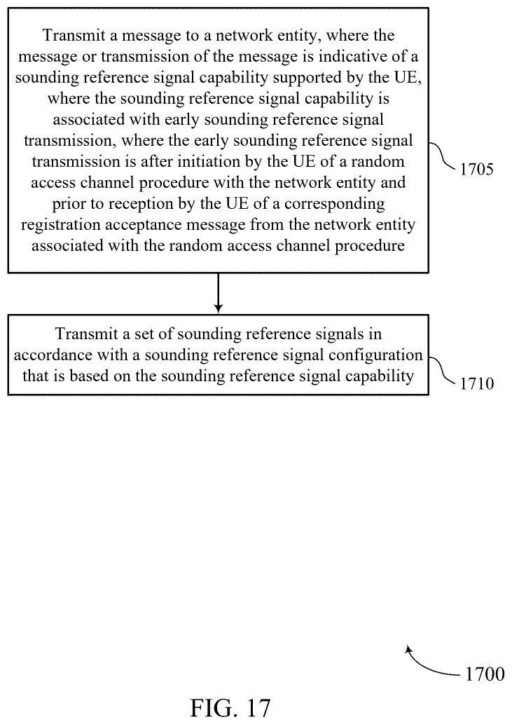

FIG. 17 shows a flowchart illustrating a method 1700 that supports early SRS capability signaling in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include transmitting a message to a network entity, where the message or transmission of the message is indicative of an SRS capability supported by the UE, where the SRS capability is associated with early SRS transmission, where the early SRS transmission is after initiation by the UE of a RACH procedure with the network entity and prior to reception by the UE of a corresponding registration acceptance message from the network entity associated with the RACH procedure. The operations of 1705 may be performed in accordance with examples as disclosed herein. In some examples, aspects of the operations of 1705 may be performed by an SRS capability indication manager 1125 as described with reference to FIG. 11.

At 1710, the method may include transmitting a set of SRSs in accordance with an SRS configuration that is based on the SRS capability. The operations of 1710 may be performed in accordance with examples as disclosed herein. In some examples, aspects of the operations of 1710 may be performed by an SRS transmission manager 1130 as described with reference to FIG. 11.

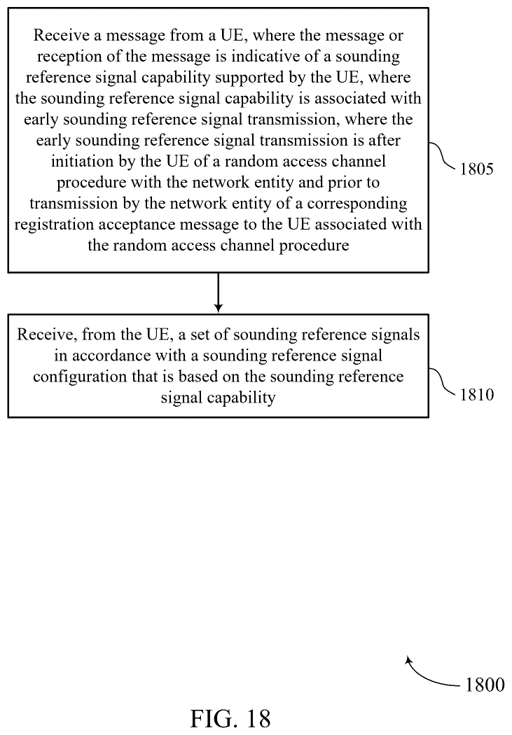

FIG. 18 shows a flowchart illustrating a method 1800 that supports early SRS capability signaling in accordance with one or more aspects of the present disclosure. The operations of the method 1800 may be implemented by a network entity or its components as described herein. For example, the operations of the method 1800 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1805, the method may include receiving a message from a UE, where the message or reception of the message is indicative of an SRS capability supported by the UE, where the SRS capability is associated with early SRS transmission, where the early SRS transmission is after initiation by the UE of a RACH procedure with the network entity and prior to transmission by the network entity of a corresponding registration acceptance message to the UE associated with the RACH procedure. The operations of 1805 may be performed in accordance with examples as disclosed herein. In some examples, aspects of the operations of 1805 may be performed by an SRS capability indication manager 1525 as described with reference to FIG. 15.

At 1810, the method may include receiving, from the UE, a set of SRSs in accordance with an SRS configuration that is based on the SRS capability. The operations of 1810 may be performed in accordance with examples as disclosed herein. In some examples, aspects of the operations of 1810 may be performed by an SRS reception manager 1530 as described with reference to FIG. 15.

The following provides an overview of aspects of the present disclosure:

Aspect 1: A method for wireless communications at a UE, comprising: transmitting a message to a network entity, wherein the message or transmission of the message is indicative of a SRS capability supported by the UE, wherein the SRS capability is associated with early SRS transmission, wherein the early SRS transmission is after initiation by the UE of a RACH procedure with the network entity and prior to reception by the UE of a corresponding registration acceptance message from the network entity associated with the RACH procedure; and transmitting a set of SRSs in accordance with a SRS configuration that is based at least in part on the SRS capability.

Aspect 2: The method of aspect 1, wherein the message is an initial message of the RACH procedure, and the message includes an indication of the SRS capability.

Aspect 3: The method of aspect 2, wherein the indication in the initial message indicates the SRS capability from a plurality of candidate SRS capabilities based at least in part on a RACH occasion via which the initial message is transmitted or a transmission parameter of the initial message, and the plurality of candidate SRS capabilities are mapped to different RACH occasion or different transmission parameters.

Aspect 4: The method of any of aspects 2 through 3, further comprising: receiving, from the network entity and based at least in part on the initial message, a second message of the RACH procedure that triggers the set of SRSs and indicates the SRS configuration for the set of SRSs.

Aspect 5: The method of any of aspects 2 through 4, further comprising: receiving, from the network entity, SI that indicates a plurality of indices associated with respective SRS configurations; and receiving, from the network entity and based at least in part on the initial message, a second message of the RACH procedure that triggers the set of SRSs and indicates an index from the plurality of indices, wherein the index indicates selection of the SRS configuration.

Aspect 6: The method of any of aspects 1 through 5, further comprising: receiving, from the network entity, SI that indicates a plurality of SRS capabilities, wherein the plurality of SRS capabilities comprises the SRS capability.

Aspect 7: The method of aspect 6, wherein the message is a random access message of the RACH procedure, the message includes an indication of the SRS capability, and the message indicates one or more SRS transmission parameters in addition to the SRS capability.

Aspect 8: The method of any of aspect 6, wherein transmitting the message comprises: transmitting the set of SRSs in accordance with the SRS capability.

Aspect 9: The method of any of aspects 1 through 10, further comprising: receiving, from the network entity, a request for SRS capability information from the UE, wherein transmission of the message is based at least in part on the request.

Aspect 11: The method of aspect 9, wherein receiving the request comprises: receiving the request via SI.

Aspect 12: The method of aspect 9, further comprising: transmitting an initial message of the RACH procedure; receiving, from the network entity, a second message of the RACH procedure based at least in part on the initial message, wherein the second message comprises the request; and transmitting, to the network entity and based at least in part on the request, a third message of the RACH procedure, wherein the third message is the message.

Aspect 13: The method of any of aspects 1 through 7, 9, or 12, wherein transmitting the message comprises: transmitting a first initial access message of the RACH procedure via a first RACH occasion and in accordance with a first set of transmission parameters; and transmitting a second initial access message of the RACH procedure via a second RACH occasion and in accordance with a second set of transmission parameters, wherein the message is indicative of the SRS capability at least in part on an offset between the first RACH occasion and the second RACH occasion, the first set of transmission parameters, the second set of transmission parameters, or any combination thereof.

Aspect 14: The method of any of aspects 1 through 13, wherein the message is indicative of the SRS capability based at least in part on satisfaction of a triggering condition associated with the SRS capability.

Aspect 15: The method of any of aspects 1 through 14, further comprising: transmitting, prior to the reception by the UE of the corresponding registration acceptance message from the network entity, an indication of one or more additional operating parameters of the UE.

Aspect 16: The method of any of aspects 1 through 15, further comprising: randomly selecting a root sequence index, a cyclic shift, a comb offset, or a combination thereof to apply to transmission of the set of SRSs.

Aspect 17: The method of aspect 16, further comprising: transmitting a second message to the network entity that indicates the root sequence index, the cyclic shift, the comb offset, or the combination thereof.

Aspect 18: The method of any of aspects 1 through 17, wherein the SRS capability comprises one or more of: SRS scheduling type capability information, SRS type capability information, antenna port information; SRS antenna switching capability information, aperiodic SRS offset capability information, physical uplink shared channel capability information, or SRS triggering capability information.

Aspect 19: The method of any of aspects 1 through 18, wherein receiving, from the network entity and based at least in part on the message, a second message that indicates the SRS configuration, wherein the SRS configuration comprises: a scheduling type of the set of SRSs, a quantity of resource sets associated with the set of SRSs, a quantity of resources per resource set of the quantity of resource sets, antenna port information, comb offset information, a root sequence, a cyclic shift, frequency hopping information, repetition information, spatial filter information, time offset information, transmission power control information, or codebook type information.

Aspect 20: A method for wireless communications at a network entity, comprising: receiving a message from a UE, wherein the message or reception of the message is indicative of a SRS capability supported by the UE, wherein the SRS capability is associated with early SRS transmission, wherein the early SRS transmission is after initiation by the UE of a RACH procedure with the network entity and prior to transmission by the network entity of a corresponding registration acceptance message to the UE associated with the RACH procedure; and receiving, from the UE, a set of SRSs in accordance with a SRS configuration that is based at least in part on the SRS capability

Aspect 21: The method of aspect 20, wherein the message is an initial message of the RACH procedure, and the message includes an indication of the SRS capability.

Aspect 22: The method of aspect 21, wherein the indication in the initial message indicates the SRS capability from a plurality of candidate SRS capabilities based at least in part on a RACH occasion via which the initial message is transmitted or a transmission parameter of the initial message, and the plurality of candidate SRS capabilities are mapped to different RACH occasion or different transmission parameters.

Aspect 23: The method of any of aspects 21 through 22, further comprising: transmitting, to the UE and based at least in part on the initial message, a second message of the RACH procedure that triggers the set of SRSs and indicates the SRS configuration for the set of SRSs.

Aspect 24: The method of any of aspects 21 through 23, further comprising: transmitting SI that indicates a plurality of indices associated with respective SRS configurations; and transmitting, to the UE and based at least in part on the initial message, a second message of the RACH procedure that triggers the set of SRSs and indicates an index from the plurality of indices, wherein the index indicates selection of the SRS configuration.

Aspect 25: The method of any of aspects 20 through 24, further comprising: transmitting SI that indicates a plurality of SRS capabilities, wherein the plurality of SRS capabilities comprises the SRS capability.

Aspect 26: The method of aspect 25, wherein the message is a random access message of the RACH procedure, the message includes an indication of the SRS capability, the message indicates one or more SRS transmission parameters in addition to the SRS capability.

Aspect 27: The method of aspect 25, wherein receiving the message comprises: receiving the set of SRSs in accordance with the SRS capability.

Aspect 28: The method of any of aspects 20 through 27, further comprising: transmitting, to the UE, a request for SRS capability information from the UE, wherein transmission of the message is based at least in part on the request.

Aspect 29: The method of aspect 28, wherein transmitting the request comprises: transmitting the request via SI.

Aspect 30: The method of aspect 28, further comprising: receiving, from the UE, an initial message of the RACH procedure; transmitting, to the UE, a second message of the RACH procedure based at least in part on the initial message, wherein the second message comprises the request; and receiving, from the UE and based at least in part on the request, a third message of the RACH procedure, wherein the third message is the message.

Aspect 31: The method of any of aspects 20 through 25, 27, or 30, wherein receiving the message comprises: receiving, from the UE, a first initial access message of the RACH procedure via a first RACH occasion and in accordance with a first set of transmission parameters; and receiving, from the UE, a second initial access message of the RACH procedure via a second RACH occasion and in accordance with a second set of transmission parameters, wherein the message is indicative of the SRS capability at least in part on an offset between the first RACH occasion and the second RACH occasion, the first set of transmission parameters, the second set of transmission parameters, or any combination thereof.

Aspect 32: The method of any of aspects 20 through 31, wherein the message is indicative of the SRS capability based at least in part on satisfaction of a triggering condition associated with the SRS capability.

Aspect 33: The method of any of aspects 20 through 32, further comprising: receiving, from the UE and prior to the transmission of the corresponding registration acceptance message from the network entity, an indication of one or more additional operating parameters of the UE.

Aspect 34: The method of any of aspects 20 through 33, further comprising: receiving, from the UE, a second message that indicates a root sequence index, a cyclic shift, a comb offset, or a combination thereof that is applied to the set of SRSs.

Aspect 35: The method of any of aspects 20 through 34, wherein the SRS capability comprises one or more of: SRS scheduling type capability information, SRS type capability information, antenna port information; SRS antenna switching capability information, aperiodic SRS offset capability information, physical uplink shared channel capability information, or SRS triggering capability information.

Aspect 36: The method of any of aspects 20 through 35, wherein transmitting, to the UE and based at least in part on the message, a second message that indicates the SRS configuration, wherein the SRS configuration comprises: a scheduling type of the set of SRSs, a quantity of resource sets associated with the set of SRSs, a quantity of resources per resource set of the quantity of resource sets, antenna port information, comb offset information, a root sequence, a cyclic shift, frequency hopping information, repetition information, spatial filter information, time offset information, transmission power control information, or codebook type information.

Aspect 37: A UE for wireless communications, comprising one or more memories storing processor-executable code, and one or more processors coupled with the one or more memories and individually or collectively operable to execute the code to cause the UE to perform a method of any of aspects 1 through 19.

Aspect 38: A UE for wireless communications, comprising at least one means for performing a method of any of aspects 1 through 19.

Aspect 39: A non-transitory computer-readable medium storing code for wireless communications, the code comprising instructions executable by one or more processors to perform a method of any of aspects 1 through 19.

Aspect 40: A network entity for wireless communications, comprising one or more memories storing processor-executable code, and one or more processors coupled with the one or more memories and individually or collectively operable to execute the code to cause the network entity to perform a method of any of aspects 20 through 36.

Aspect 41: A network entity for wireless communications, comprising at least one means for performing a method of any of aspects 20 through 36.

Aspect 42: A non-transitory computer-readable medium storing code for wireless communications, the code comprising instructions executable by one or more processors to perform a method of any of aspects 20 through 36.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a message to a network entity, wherein the message or transmission of the message is indicative of a sounding reference signal capability supported by the UE, wherein the sounding reference signal capability is associated with early sounding reference signal transmission, wherein the early sounding reference signal transmission is after initiation by the UE of a random access channel procedure with the network entity and prior to reception by the UE of a corresponding registration acceptance message from the network entity associated with the random access channel procedure; and
transmit a set of sounding reference signals in accordance with a sounding reference signal configuration that is based at least in part on the sounding reference signal capability.

2. The UE of claim 1, wherein:
the message is an initial message of the random access channel procedure, and
the message includes an indication of the sounding reference signal capability.

3. The UE of claim 2, wherein:
the indication in the initial message indicates the sounding reference signal capability from a plurality of candidate sounding reference signal capabilities based at least in part on a random access channel occasion via which the initial message is transmitted or a transmission parameter of the initial message, and
the plurality of candidate sounding reference signal capabilities are mapped to different random access channel occasion or different transmission parameters.

4. The UE of claim 2, wherein the one or more processors are individually or collectively further operable to execute the code to cause the UE to:
receive, from the network entity and based at least in part on the initial message, a second message of the random access channel procedure that triggers the set of sounding reference signals and indicates the sounding reference signal configuration for the set of sounding reference signals.

5. The UE of claim 2, wherein the one or more processors are individually or collectively further operable to execute the code to cause the UE to:
receive, from the network entity, system information that indicates a plurality of indices associated with respective sounding reference signal configurations; and
receive, from the network entity and based at least in part on the initial message, a second message of the random access channel procedure that triggers the set of sounding reference signals and indicates an index from the plurality of indices, wherein the index indicates selection of the sounding reference signal configuration.

6. The UE of claim 1, wherein the one or more processors are individually or collectively further operable to execute the code to cause the UE to:
receive, from the network entity, system information that indicates a plurality of sounding reference signal capabilities, wherein the plurality of sounding reference signal capabilities comprises the sounding reference signal capability.

7. The UE of claim 6, wherein:
the message is a random access message of the random access channel procedure,
the message includes an indication of the sounding reference signal capability, and
the message indicates one or more sounding reference signal transmission parameters in addition to the sounding reference signal capability.

8. The UE of claim 6, wherein, to transmit the message, the one or more processors are individually or collectively operable to execute the code to cause the UE to:
transmit the set of sounding reference signals in accordance with the sounding reference signal capability.

9. The UE of claim 1, wherein the one or more processors are individually or collectively further operable to execute the code to cause the UE to:
receive, from the network entity, a request for sounding reference signal capability information from the UE, wherein transmission of the message is based at least in part on the request.

10. The UE of claim 9, wherein, to receive the request, the one or more processors are individually or collectively operable to execute the code to cause the UE to:
receive the request via system information.

11. The UE of claim 9, wherein the one or more processors are individually or collectively further operable to execute the code to cause the UE to:
transmit an initial message of the random access channel procedure;
receive, from the network entity, a second message of the random access channel procedure based at least in part on the initial message, wherein the second message comprises the request; and
transmit, to the network entity and based at least in part on the request, a third message of the random access channel procedure, wherein the third message is the message.

12. The UE of claim 1, wherein, to transmit the message, the one or more processors are individually or collectively operable to execute the code to cause the UE to:
transmit a first initial access message of the random access channel procedure via a first random access channel occasion and in accordance with a first set of transmission parameters; and
transmit a second initial access message of the random access channel procedure via a second random access channel occasion and in accordance with a second set of transmission parameters, wherein the message is indicative of the sounding reference signal capability at least in part on an offset between the first random access channel occasion and the second random access channel occasion, the first set of transmission parameters, the second set of transmission parameters, or any combination thereof.

13. The UE of claim 1, wherein the message is indicative of the sounding reference signal capability based at least in part on satisfaction of a triggering condition associated with the sounding reference signal capability.

14. The UE of claim 1, wherein the one or more processors are individually or collectively further operable to execute the code to cause the UE to:
transmit, prior to the reception by the UE of the corresponding registration acceptance message from the network entity, an indication of one or more additional operating parameters of the UE.

15. The UE of claim 1, wherein the one or more processors are individually or collectively further operable to execute the code to cause the UE to:
randomly select a root sequence index, a cyclic shift, a comb offset, or a combination thereof to apply to transmission of the set of sounding reference signals.

16. The UE of claim 15, wherein the one or more processors are individually or collectively further operable to execute the code to cause the UE to:
transmit a second message to the network entity that indicates the root sequence index, the cyclic shift, the comb offset, or the combination thereof.

17. The UE of claim 1, wherein the sounding reference signal capability comprises one or more of: sounding reference signal scheduling type capability information, sounding reference signal type capability information, antenna port information; sounding reference signal antenna switching capability information, aperiodic sounding reference signal offset capability information, physical uplink shared channel capability information, or sounding reference signal triggering capability information.

18. The UE of claim 1, wherein receiving, from the network entity and based at least in part on the message, a second message that indicates the sounding reference signal configuration, wherein the sounding reference signal configuration comprises: a scheduling type of the set of sounding reference signals, a quantity of resource sets associated with the set of sounding reference signals, a quantity of resources per resource set of the quantity of resource sets, antenna port information, comb offset information, a root sequence, a cyclic shift, frequency hopping information, repetition information, spatial filter information, time offset information, transmission power control information, or codebook type information.

19. A method for wireless communications at a user equipment (UE), comprising:
transmitting a message to a network entity, wherein the message or transmission of the message is indicative of a sounding reference signal capability supported by the UE, wherein the sounding reference signal capability is associated with early sounding reference signal transmission, wherein the early sounding reference signal transmission is after initiation by the UE of a random access channel procedure with the network entity and prior to reception by the UE of a corresponding registration acceptance message from the network entity associated with the random access channel procedure; and
transmitting a set of sounding reference signals in accordance with a sounding reference signal configuration that is based at least in part on the sounding reference signal capability.

20. A non-transitory computer-readable medium storing code for wireless communications at a user equipment (UE), the code comprising instructions executable by one or more processors to:
transmit a message to a network entity, wherein the message or transmission of the message is indicative of a sounding reference signal capability supported by the UE, wherein the sounding reference signal capability is associated with early sounding reference signal transmission, wherein the early sounding reference signal transmission is after initiation by the UE of a random access channel procedure with the network entity and prior to reception by the UE of a corresponding registration acceptance message from the network entity associated with the random access channel procedure; and
transmit a set of sounding reference signals in accordance with a sounding reference signal configuration that is based at least in part on the sounding reference signal capability.
